(19) United States
(12) Patent Application Publication
(10) Pub. No.: US 2026/0288833 A1
(43) Pub. Date: Sep. 24, 2026

(54) SYSTEM

(71) Applicant: SoftBank Group Corp., Tokyo (JP)

(72) Inventor: Hidetaka HAYASHI, Tokyo (JP)

(73) Assignee: SoftBank Group Corp., Tokyo (JP)

(21) Appl. No.: 19/568,841

(22) Filed: Mar. 17, 2026

(30) Foreign Application Priority Data
Mar. 19, 2025 (JP) 2025-045252

(51) Int. Cl. G06F 16/334; G06F 16/332; G06F 16/335

(52) U.S. Cl. CPC G06F 16/3344; G06F 16/3322; G06F 16/337

(57) ABSTRACT

A system includes a processor that is configured to receive a question expressed in natural language from a user, analyze the received question and generate a prompt for instructing a generative artificial intelligence model to understand an intent of the question, and input the prompt to the generative artificial intelligence model, access a storage service based on the intent obtained from the generative artificial intelligence model, search related information in the storage service, and derive an answer, automatically classify the searched information based on predefined categories, recognize an emotional state of the user and adjust at least one of search results and autocomplete prediction candidates based on the emotional state, and automatically translate information written in different languages by using a machine translation algorithm.

### CROSS-REFERENCE TO RELATED APPLICATION

This application is based on and claims priority under 35 USC 119 from Japanese Patent Application No. 2025-045252 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional storage services and information retrieval systems require users to know specific file names, rigid keywords, or explicit metadata in order to obtain necessary information from large-scale document repositories. Such systems are not well adapted to questions expressed in natural language and therefore fail to accurately capture the user's true intent, especially when the question is broad, ambiguous, or context dependent. In addition, known systems typically perform only simple keyword-based search and do not provide integrated automatic classification of retrieved information into meaningful categories, resulting in poor organization and low efficiency when handling large volumes of technical documents and specifications.

Furthermore, conventional systems generally do not take into account the emotional state of the user. As a result, search results, answer presentations, and autocomplete suggestions are not dynamically adjusted to the user's current condition or preference, which can lead to user frustration, reduced usability, and suboptimal interaction. Also, existing solutions that must deal with information written in multiple languages often require manual translation or separate tools, thereby increasing operational burden and introducing delays and inconsistencies.

Accordingly, there is a need for a system that is capable of: receiving and interpreting natural language questions, accurately understanding the user's intent by leveraging a generative artificial intelligence model, automatically accessing and searching a storage service based on the understood intent, deriving appropriate answers, automatically classifying the retrieved information into predefined categories, adapting search and autocomplete behavior based on the user's emotional state, and automatically translating information across different languages using a machine translation algorithm. The present invention is directed to at least solving these problems.

### SUMMARY

In order to solve at least the above-described problems, the present invention provides a system comprising a processor, wherein the processor is configured to receive a question expressed in natural language from a user, analyze the received question, and generate a prompt for instructing a generative artificial intelligence model to understand an intent of the question. The processor is further configured to input the generated prompt to the generative artificial intelligence model and obtain, from the generative artificial intelligence model, information indicating the intent of the question.

Based on the obtained intent, the processor is configured to access a storage service, search related information stored in the storage service, and derive an answer corresponding to the user's question. The processor is also configured to automatically classify the searched information into predefined categories, such as specifications, technical documents, or other document types, thereby improving organization and subsequent retrieval of the information. Moreover, the processor is configured to recognize an emotional state of the user, for example by analyzing user inputs or interaction patterns, and to adjust at least one of search results and autocomplete prediction candidates based on the recognized emotional state, so that the interaction can be adapted to user conditions and preferences. In addition, the processor is configured to automatically translate information written in different languages by using a machine translation algorithm, whereby the user can seamlessly obtain and utilize information regardless of the original language in which the information is stored.

In one preferred implementation, the processor is configured to derive the answer from specification documents and technical documents stored in the storage service by using at least one of keyword matching and document structure analysis, thereby increasing accuracy when dealing with structured technical materials. In another preferred implementation, the processor is configured to analyze information stored in the storage service by using natural language processing techniques and automatically classify the information into appropriate categories by using at least one of topic modeling and clustering algorithms. Through these means, the system achieves integrated natural language question answering, automatic classification, emotion-aware interaction, and multilingual support in a unified storage service environment.

The term “system” refers to an integrated arrangement of hardware and software components, including at least one processor and associated memory and interfaces, that cooperatively perform the functions described in the claims.

The term “processor” refers to one or more hardware processing units, such as a central processing unit (CPU), a graphics processing unit (GPU), a digital signal processor (DSP), an application specific integrated circuit (ASIC), a field programmable gate array (FPGA), or any combination thereof, capable of executing instructions to implement the claimed functions.

The term “user” refers to a human operator or an entity acting on behalf of a human operator that interacts with the system by inputting questions, receiving answers, and using the search, classification, autocomplete, and translation functions.

The term “natural language” refers to a human language, such as English, Japanese, or any other spoken or written language, as opposed to a formal programming language or a purely symbolic query language.

The term “question” refers to an inquiry expressed in natural language by the user, requesting information, clarification, or explanation about one or more topics associated with data stored in a storage service.

The term “generative artificial intelligence model” refers to a machine learning model, such as a large language model or other generative model, that is trained to generate or transform text or other data and is capable of inferring an intent of a question based on an input prompt.

The term “prompt” refers to a text or structured input prepared for the generative artificial intelligence model, which includes at least part of the user's question and may include additional instructions or context, for the purpose of causing the model to interpret or output the intent of the question.

The term “intent” refers to the underlying meaning, purpose, or information need expressed by the user's question, as interpreted or inferred by the generative artificial intelligence model based on the prompt.

The term “storage service” refers to a data storage system, such as a cloud storage service, file server, database, or document management system, configured to store, manage, and provide access to documents and other information.

The term “related information” refers to data, documents, document sections, or other content stored in the storage service that are determined, based on the inferred intent, to be relevant to answering the user's question.

The term “answer” refers to a response generated by the system, based on related information retrieved from the storage service, that addresses the intent of the user's question in natural language or another user-understandable format.

The term “automatically classify” refers to the operation of assigning, without requiring manual selection by the user, one or more categories to information based on its content using predefined rules, machine learning models, or other algorithms.

The term “predefined categories” refers to a set of categories, such as specifications, technical documents, manuals, or design documents, that are defined in advance by a system administrator, developer, or configuration, and used as targets for classification.

The term “emotional state” refers to an estimated or detected psychological condition of the user, such as frustration, confusion, satisfaction, or confidence, inferred from user inputs, interaction patterns, or other signals.

The term “autocomplete prediction candidates” refers to one or more suggested completions or continuations of a partially entered input, such as a partially typed query or phrase, presented to the user for selection to complete the input more efficiently.

The term “search results” refers to one or more items of information, including documents, document sections, or generated answers, that are returned by the system in response to a search or question based on relevance to the user's intent.

The term “machine translation algorithm” refers to a software-implemented method, such as a statistical, rule-based, neural network-based, or hybrid translation model, that automatically converts text or other language data from a source language into a target language.

The term “specification documents” refers to documents stored in the storage service that describe technical or functional specifications of products, systems, or components, including but not limited to datasheets, product specifications, and requirement documents.

The term “technical documents” refers to documents stored in the storage service that contain technical information, such as design documents, manuals, engineering reports, standards, and similar materials related to technical subjects.

The term “keyword matching” refers to a search technique in which the presence, frequency, or position of specific words or phrases in documents is compared with words or phrases in a query to determine relevance.

The term “document structure analysis” refers to analysis of structural elements of a document, such as headings, sections, paragraphs, tables, and lists, in order to identify and extract information relevant to a query or classification task.

The term “natural language processing techniques” refers to computational methods for analyzing, interpreting, and processing human language, including but not limited to tokenization, part-of-speech tagging, named entity recognition, parsing, and semantic analysis.

The term “topic modeling” refers to a type of unsupervised machine learning algorithm that identifies latent topics within a collection of documents by modeling the distribution of words and grouping words that frequently co-occur.

The term “clustering algorithms” refers to unsupervised machine learning methods that group data items, such as documents or document segments, into clusters based on similarity measures, without requiring labeled training data.

The term “information stored in the storage service” refers to any data, including documents, document segments, metadata, and other digital content, that resides within or is accessible through the storage service.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

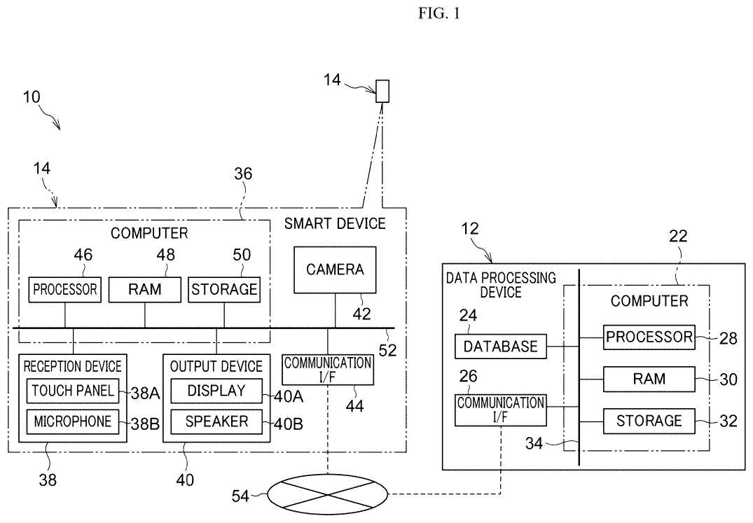

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

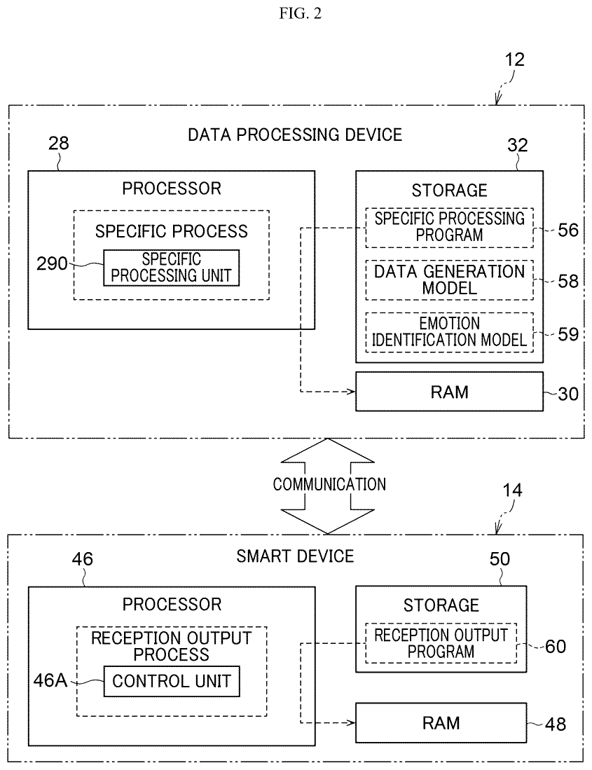

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information retrieval systems that accept natural-language queries typically rely on shallow keyword matching and static ranking over stored documents. In such systems, a processor often searches a document collection using literal terms contained in the user's query and returns entire documents or unfiltered passages to the terminal. As a result, the processor is not able to accurately infer the user's intent, fails to identify truly relevant segments in large and heterogeneous storage services, and often produces verbose, redundant, or incomplete results. This leads to significant cognitive load on the user, who must manually scan lengthy documents or navigate multiple files in order to locate a concise answer.

In many deployed architectures, even when a generative AI model is used, the model is invoked only at a superficial layer, for example to rephrase search results, without tight coupling between model-based intent extraction, document retrieval, and prompt construction. The processor typically does not generate structured prompt sentences that explicitly encode both the user's intent and carefully selected document segments.

Consequently, the generative AI model tends to hallucinate information, mix unrelated content, or omit critical technical details because the model is not constrained to operate on a curated, context-appropriate subset of the storage contents.

Furthermore, existing systems generally do not treat prompt sentence generation and document selection as first-class computational tasks that improve the behavior of the underlying computing platform. Many systems fail to use model-assisted relevance scoring to determine which segments from an external storage service should be included in a prompt, nor do they employ distributed-representation similarity or clustering to organize document segments into coherent categories before feeding them to the generative AI model. As a result, the processor often transmits unnecessarily large or noisy contexts to the model, thereby increasing computation time, communication bandwidth, and memory consumption, and degrading answer quality.

Additionally, the emotional state of the user, as inferred from user inputs or interaction patterns, is rarely incorporated into the core retrieval and generation pipeline. Conventional systems might change a user interface theme or wording superficially, but they do not adjust core technical parameters such as search query formation, prompt structure, or answer ordering at the processor level. This lack of emotional-state-aware control prevents the computing system from adapting its retrieval depth, level of detail, or disambiguation strategy to the user's current needs, leading to suboptimal use of processor resources and user frustration.

Moreover, when information resources in different languages are stored in distributed storage services, many existing systems either ignore non-native language content or perform ad-hoc translation at the user interface layer. The processor does not consistently normalize multi-language document sets into a unified language for internal processing, which complicates indexing, similarity computation, and prompt construction. As a consequence, cross-language information remains fragmented, the quality of generated answers degrades, and processing pipelines become more complex and error prone.

Accordingly, there is a need for an improved computer-implemented system in which a processor (i) cooperatively uses a generative AI model for both intent extraction and guided answer generation, (ii) constructs structured prompt sentences that integrate model-derived intent and carefully selected text segments from external storage services, (iii) performs model-informed relevance scoring, distributed-representation similarity computation, and automatic categorization of document segments, (iv) dynamically adjusts search and prompt behavior based on an estimated emotional state of the user, and (v) performs unified-language translation of heterogeneous information resources. Such a system should improve the efficiency, accuracy, and consistency of the information retrieval and answer generation pipeline, and thereby provide a concrete improvement to the functioning of the computer system itself, rather than merely automating a mental process.

The specific processing by the specific processing unit 290 of the data processing device 12 in Example 1 is realized by the following means.

The present invention provides a server comprising a processor configured to receive, from a terminal operated by a user, interface data including a question expressed in natural language and to transmit response data to the terminal via a communication network; to convert the received natural-language question into an internal representation suitable for analysis; to generate an analysis prompt sentence for extracting an intent and important terms of the question; to input the analysis prompt sentence into a generative AI model and obtain, from the generative AI model, a response indicating the intent and the important terms; to generate, on the basis of the obtained intent and important terms, a search request for information resources stored in an external storage service; to acquire, from the external storage service, a plurality of documents including specification information and technical information; to extract, from the plurality of documents, text segments related to the question; to construct an answer-generation prompt sentence by combining the extracted text segments with the natural-language question; to input the answer-generation prompt sentence into the generative AI model and cause the generative AI model to generate an answer sentence in natural language based on the extracted text segments; to format the generated answer sentence into a predetermined output format, associate the formatted answer sentence with the question as response data, and transmit the response data to the terminal; to perform structural-information analysis and full-text search on the acquired documents, calculate, based on an analysis result of the generative AI model, a relevance score for each text segment, and include, in the answer-generation prompt sentence, only text segments whose relevance score exceeds a predetermined threshold; to perform similarity computation or clustering computation based on distributed representations for the natural-language question and the text segments, automatically assign the documents or the text segments to categories according to a result of the computation, and selectively change content or structure of the answer-generation prompt sentence by using category information; to classify the documents or text segments into categories based on topic information or attribute information; to estimate an emotional state of the user on the basis of utterance content or operation history of the user and adjust at least one of the search request, the answer-generation prompt sentence, and an order of presentation on the terminal in accordance with the estimated emotional state; and to convert information resources in different languages stored in the external storage service into a unified language by machine translation processing and generate the answer sentence on the basis of the information resources converted into the unified language. This enables the computing system to more efficiently and accurately identify relevant document segments, to construct constrained and context-appropriate prompt sentences for the generative AI model, to reduce unnecessary data transfer and processing within the model, to adapt retrieval and generation behavior to user-specific emotional conditions, and to normalize heterogeneous multi-language resources, thereby providing a concrete improvement in the functioning and technical performance of the underlying computer system.

The term “processor” refers to one or more hardware computation units, such as a central processing unit, graphics processing unit, or dedicated accelerator, configured to execute instructions that implement the functions described in the present specification.

The term “terminal” refers to an electronic device operated by a user, such as a client computer, mobile device, or display apparatus, that exchanges data with the server over a communication network and presents information to the user.

The term “communication network” refers to any wired or wireless data transmission infrastructure, including local networks and wide area networks, that enables data exchange between the server and the terminal.

The term “interface data” refers to data transmitted between the terminal and the server that represents at least a natural-language question, a response, or control information related to input and output operations.

The term “natural-language question” refers to a sequence of characters or symbols expressing an inquiry in a human language, without requiring the user to follow a predefined command or query syntax.

The term “internal representation” refers to a data structure generated by the processor from received data, such as token sequences, feature vectors, or parsed trees, which is suitable for subsequent computational analysis.

The term “analysis prompt sentence” refers to a text or token sequence generated by the processor that instructs a generative AI model to analyze a natural-language question and to output an intent and important terms.

The term “intent” refers to an abstract representation of the purpose or objective underlying a natural-language question, as inferred by computational analysis or a generative AI model.

The term “important terms” refers to words, phrases, or expressions extracted from a natural-language question or related data that are determined to be relevant for search or reasoning.

The term “generative AI model” refers to a machine-learned model, such as a neural network language model, that receives input data including a prompt sentence and outputs generated text or structured information based on learned statistical relationships.

The term “prompt sentence” refers to text or tokenized content provided as input to a generative AI model, including instructions, questions, and contextual information that guide the model's output.

The term “external storage service” refers to a storage system or service accessible over a network, such as a remote file store or object store, in which documents or information resources are stored independently of the processor's main memory.

The term “information resources” refers to digital content, including documents, records, or data sets, that contain information usable for answering a natural-language question.

The term “specification information” refers to structured or semi-structured descriptive content that defines characteristics, performance parameters, or functions of an object such as a product, component, or service.

The term “technical information” refers to content related to technical structures, operations, designs, or procedures, such as manuals, technical reports, or design documents.

The term “document” refers to any digital file containing textual, image, or mixed content, including but not limited to text files, markup files, and page-description files that can be processed to extract text segments.

The term “text segment” refers to a portion of document text, such as a sentence, paragraph, or predefined character range, extracted for separate analysis or use in prompt construction.

The term “search request” refers to data generated by the processor that specifies at least one query condition, keyword, or filter for retrieving information resources from an external storage service.

The term “answer-generation prompt sentence” refers to a prompt sentence that combines at least a natural-language question and one or more text segments, and that instructs a generative AI model to generate an answer sentence.

The term “answer sentence” refers to a natural-language text generated by a generative AI model in response to an answer-generation prompt sentence and intended to answer a user's question.

The term “predetermined output format” refers to a defined structural format for presenting an answer, such as a particular textual template or data schema, specified independently of any specific question.

The term “response data” refers to data generated by the processor that includes at least an answer sentence and association information linking the answer sentence to the corresponding natural-language question.

The term “structural-information analysis” refers to processing that interprets or utilizes structure within a document, such as headings, sections, tables, or markup tags, to identify or locate content.

The term “full-text search” refers to a search technique in which a processor analyzes text content of one or more documents in its entirety to find occurrences of specified terms or patterns.

The term “relevance score” refers to a numerical or ordinal value that indicates a degree of relevance between a text segment and a natural-language question, computed according to a defined criterion.

The term “threshold” refers to a reference value that is used to determine whether a computed metric, such as a relevance score, satisfies a condition such as inclusion or exclusion.

The term “distributed representation” refers to a vector or similar multidimensional numerical representation of text or other data, typically generated by machine-learning models, in which semantic relationships are encoded in relative positions in a vector space.

The term “similarity computation” refers to a numerical computation, such as a distance or similarity metric, performed over distributed representations to evaluate the degree of similarity between two or more items.

The term “clustering computation” refers to a process that partitions multiple items, based on their features or distributed representations, into groups such that items in the same group are more similar to each other than to items in other groups.

The term “category” refers to a logical grouping or label assigned to one or more documents or text segments based on topic information, attribute information, or computational analysis.

The term “topic information” refers to data or features that indicate a theme, subject, or area of content to which a document or text segment relates.

The term “attribute information” refers to metadata or descriptive data items associated with a document or text segment, such as type, source, creation time, or domain.

The term “emotional state” refers to an estimated affective condition of a user, such as a level of frustration, confusion, urgency, or satisfaction, inferred by analysis of user inputs or interaction behavior.

The term “utterance content” refers to linguistic data produced by a user, including textual input or transcribed speech, that expresses queries, commands, or reactions.

The term “operation history” refers to data representing past user interactions with a terminal or system, such as input sequences, timing of actions, navigation paths, or selection patterns.

The term “order of presentation” refers to a sequence in which search results, answers, or other information items are displayed to a user on a terminal.

The term “information resources in different languages” refers to information resources whose main content is expressed in different human languages from one another.

The term “unified language” refers to a single selected language into which information resources originally expressed in different languages are converted for normalized internal processing.

The term “machine translation processing” refers to automatic translation performed by a software component or model, which converts text from a source language into a target language without human intervention.

In one embodiment, a server cooperates with one or more terminals operated by users to implement the system described in the claims. The server includes at least one processor, a main memory, a non-volatile storage device, and a network interface card, and operates under control of an operating system such as a general-purpose server operating system. The terminal includes a processor, a display, an input device such as a keyboard or touch panel, and a network interface, and operates a web browser or a dedicated application.

The server and the terminal communicate over a communication network such as a local network or a wide area network using secure transport protocols.

The server executes an application program that implements a question-answering service. The application program is stored in the non-volatile storage device as executable instructions and is loaded into the main memory when executed by the processor. The server exposes an application programming interface that allows the terminal to transmit a natural-language question and to receive response data. The terminal displays a graphical user interface screen in which a user can input a question such as “How long is the battery life of the new product?”. The terminal sends the question, together with metadata such as language code and session identifier, to the server as interface data.

The server represents the received natural-language question in an internal structure suitable for downstream computation. The server, for example, uses a tokenizer derived from a transformer-based language model to map the character sequence of the question into a sequence of token identifiers. The server stores the token identifiers in an array data structure in main memory and may additionally store positional indices, sentence boundaries, and part-of-speech tags. The server normalizes the question text into a canonical character encoding and performs basic cleaning such as lowercasing and removal of control characters, thereby reducing variability of input and improving stability of the subsequent algorithms.

The server constructs an analysis prompt sentence that instructs a generative AI model to output an intent and important terms. The server uses a template that is stored as a string resource and dynamically inserts the normalized question text into the template. An example of such an analysis prompt sentence is:
Identify the main intent and important terms of the following question.
Question: “How long is the battery life of the new product?”
Output format:
Intent: [description of intent]
Keywords: [comma-separated list of important terms]

The server converts this prompt sentence into token identifiers and inputs the tokens into a generative AI model implemented as a trained neural network module. In one embodiment, the generative AI model is a transformer-based language model comprising a plurality of encoder-decoder layers, each layer including multi-head self-attention sublayers, feed-forward sublayers, and layer-normalization sublayers. The server stores model parameters such as weight matrices and bias vectors in a model storage area and loads them into accelerator memory such as a graphics processing unit memory when performing inference. The server causes the generative AI model to compute contextual embeddings for the tokens of the analysis prompt sentence. The model processes the token sequence by repeatedly applying attention score computation, softmax normalization, weighted summation, and non-linear activation functions. The server obtains an output token sequence and decodes the tokens into text, which contains the model's description of intent and important terms. The server then parses the generated text using simple rule-based patterns, such as detecting lines beginning with “Intent:” and “Keywords:”, and converts the textual description into structured data fields in memory. For example, the server may store the intent as a string field and the important terms as elements of a list data structure.

The server generates a search request based on the obtained intent and important terms. The server maps important terms to search tokens by applying stemming and synonym expansion using a domain-specific dictionary stored in a local database. The server constructs a query object, for example in the form of a tree structure representing Boolean operators and term weights, and then serializes this object into a query language understood by an external storage service such as a full-text index or object storage index. The external storage service maintains a collection of documents that may include specification information and technical information; each document is stored with associated metadata including document identifier, language code, timestamp, and category labels.

The server transmits the search request to the external storage service via the network interface. The external storage service executes a search algorithm, such as term-frequency/inverse-document-frequency (TF-IDF) or BM25 scoring, over an inverted index structure and returns identifiers of documents that match the query. The server then issues retrieval requests for specific documents, which may be stored as text files, marked-up files, or page-description files. The server receives the documents as binary data, stores them temporarily into memory buffers, and decodes them using parsers or extractors such as a document-parsing library to obtain plain text content.

The server divides the text of each document into text segments of a defined granularity, such as sentences or fixed-length windows of tokens. For each text segment, the server computes an embedding vector using a smaller transformer encoder or a sentence-embedding model.

The server similarly computes an embedding vector for the user's question, based on its internal token representation. The server then computes similarity measures, such as cosine similarity, between the question embedding and each segment embedding. The server assigns a relevance score to each text segment based on similarity and, optionally, structural-information analysis such as proximity to headings that contain important terms.

The server selects only those text segments whose relevance score exceeds a predetermined threshold or are within a top-ranked subset. This selection reduces the amount of context that must be provided to the generative AI model and eliminates unrelated or low-value text. By operating on embedding vectors and relevance scores, the server performs a technical optimization in which high-dimensional vector comparisons are used to prune the context set before generation. This directly improves processing speed, reduces memory usage and network traffic to any external model hosting environment, and increases the precision of the generated answers.

The server automatically assigns documents or text segments to categories using clustering computation based on their embedding vectors. For instance, the server may apply a k-means clustering algorithm to group segments into clusters that represent functional topics such as “battery specification,” “charging behavior,” or “safety instructions.” The server stores category identifiers in association with segment identifiers in a category table. When constructing prompts, the server can preferentially select segments from categories that are more relevant to the inferred intent. This organization of segments into categories improves data management and enables consistent retrieval of thematically coherent context, which is more efficient than ad-hoc keyword searching.

The server constructs an answer-generation prompt sentence by combining the natural-language question and the selected text segments. The server uses a prompt template stored in memory and inserts the question and the context into dedicated sections. An example of such an answer-generation prompt sentence is:

You are an assistant that answers user questions based only on the provided context.
Question: “How long is the battery life of the new product?”

### Context:

1. “Battery life: approx. 10 hours under normal usage conditions.”
2. “Charging time: about 2 hours for a full charge.”

### Instruction:

Use only the information in the Context.
If the answer is not clearly stated, say that the information is not available.

### Output Format:

Question: [user's question]
Answer: [concise answer]

The server again tokenizes this prompt sentence and inputs the tokens into the generative AI model. The model uses its transformer architecture to generate an answer sentence token by token, conditioned on both the question tokens and the context tokens. Because the server has constrained the context to highly relevant and categorized segments, the model has less incentive to interpolate unsupported content, which reduces hallucination rate and improves factual accuracy. The server decodes the model's output tokens into text and applies post-processing rules, such as trimming extraneous phrases, ensuring the requested output format, and validating that key numerical values present in the context are preserved.

The server formats the generated answer sentence into a predetermined output format, for example a structure including the original question, the answer, and source identifiers of the documents from which the context segments were extracted. The server associates this response data with a session identifier and stores it in a log database for later audit and quality analysis. The server then transmits the response data to the terminal, which displays the answer sentence and any associated metadata on a graphical user interface element such as a chat bubble or response panel.

The server additionally estimates an emotional state of the user based on utterance content and operation history. The server may maintain a time-series record of previous questions, answer views, scrolling behavior, repeated queries, or abrupt session terminations. The server extracts features from these signals, such as query length, presence of negative sentiment terms, frequency of follow-up questions, and time intervals between interactions. The server inputs a feature vector representing these attributes into a classification model, which may be a smaller neural network or a gradient-boosted tree model trained on interaction logs. The model outputs an estimated emotional category such as “confused,” “in a hurry,” or “satisfied.” The server uses this estimate to adjust technical parameters: for example, in a “confused” state, the server increases the number of context segments and instructs the generative AI model via prompt sentences to produce more explanatory and step-by-step answers; in a “hurry” state, the server reduces context size to the single most relevant segment and constrains the model via prompt to output a single concise sentence. This dynamic adjustment improves computational efficiency by avoiding unnecessary detailed generation when not needed, and improves user comprehension when more detail is appropriate.

The server further handles information resources stored in different languages. The external storage service may contain documents in multiple human languages. The server first detects the language of each document using a language identification algorithm operating on character n-gram statistics or embedding-based classification. If the language of a document differs from the unified language employed internally by the system, the server applies machine translation processing to the text segments. The server may invoke a neural machine translation model based on an encoder-decoder architecture with attention, trained on bilingual corpora. The translation model converts each segment into the unified language and outputs translated text that is then fed into the same embedding, similarity, and prompt-construction pipeline as native-language texts. By performing translation at the server side into a unified internal language, the server simplifies index structures, reduces branching logic in retrieval and prompt construction, and enables the generative AI model to work in a single linguistic domain, thereby improving the reliability of similarity measures and answer generation.

The server uses specific data structures to manage the flow of data. For example, the server may maintain a question record structure containing fields for the raw text, normalized text, token sequence, intent string, important-term list, and session identifier. The server may maintain a document index structure containing document identifiers, language codes, and pointers to stored text segments and metadata. The server may maintain a context set structure containing segment identifiers, relevance scores, embedding vectors, and category labels. By separating these structures and defining explicit relationships among them, the server can implement efficient retrieval and update operations. When a new question arrives, the server can rapidly compute similarities between the question embedding and pre-computed segment embeddings stored in a vector index, without re-processing entire documents. This reduces computational load and enables faster response times.

The server trains the generative AI model and auxiliary models offline before deployment. During training, the server (or a separate training system) defines a loss function such as cross-entropy loss between generated tokens and ground-truth tokens for language modeling tasks. The server updates the neural network weights by backpropagation using an optimization algorithm such as stochastic gradient descent with momentum or adaptive moment estimation. For the intent extraction behavior, the server may fine-tune the model using supervised training pairs of questions annotated with intents and important terms, represented in the same output format as the analysis prompt sentence. For the translation model, the server uses parallel corpora in a plurality of languages and minimizes sequence-to-sequence translation loss. The server may apply data augmentation techniques such as back-translation or paraphrasing to increase robustness. The result of this training is stored as a set of parameter tensors that the inference server loads at startup.

The server implements the above-described functions as cooperating modules. For example, the server may implement a query reception module, a prompt-construction module, a model-interface module, a document-retrieval module, an embedding-computation module, a relevance-scoring module, a categorization module, an emotion-estimation module, and a response-formatting module. Each module communicates through well-defined interfaces and passes structured data such as the question record, context set, and response data. By modularizing functions, the server can optimize and scale each module independently; for example, the embedding-computation module may run on dedicated accelerator hardware, while the document-retrieval module may be optimized for disk I/O.

The terminal remains comparatively simple. The terminal displays input controls and renders the server's response data. The terminal may provide minimal local validation, such as checking that a question is not empty, and may display indicators such as “processing” while the server computes an answer. The user reads the displayed answer, may view supporting document references, and can optionally submit follow-up questions that reuse the same processing pipeline on the server. Because the server performs the computationally intensive parts, the terminal hardware requirements remain modest.

In alternative embodiments, the server may host the generative AI model locally on accelerator hardware, or may invoke a remote model service over the communication network. In both cases, the server is responsible for constructing the analysis prompt sentence and the answer-generation prompt sentence, for selecting and ordering context segments based on relevance and category, and for post-processing the model outputs. In some embodiments, the server may switch between multiple generative AI models depending on document type, domain, or required answer length. In another variation, the server may adjust the clustering algorithm or similarity metric when the distribution of documents changes, for example switching from k-means clustering to hierarchical clustering when more granular topic separation is needed.

Because the server performs specific, non-generic computational operations—embedding generation, relevance-score-based pruning, category-based context selection, emotional-state-conditioned parameter adjustment, and unified-language translation—before and after calling the generative AI model, the system achieves measurable technical effects. These include reduced average number of tokens sent to the model per query, reduced inference time per query, improved alignment between selected context segments and user intent, lower rate of unsupported statements in the generated answers, and more efficient use of network and memory resources. These improvements are realized through the specific arrangement of data structures, prompt sentences, and algorithmic steps described above, and therefore constitute an advancement in computer technology, rather than a mere automation of human reading and answering behavior.

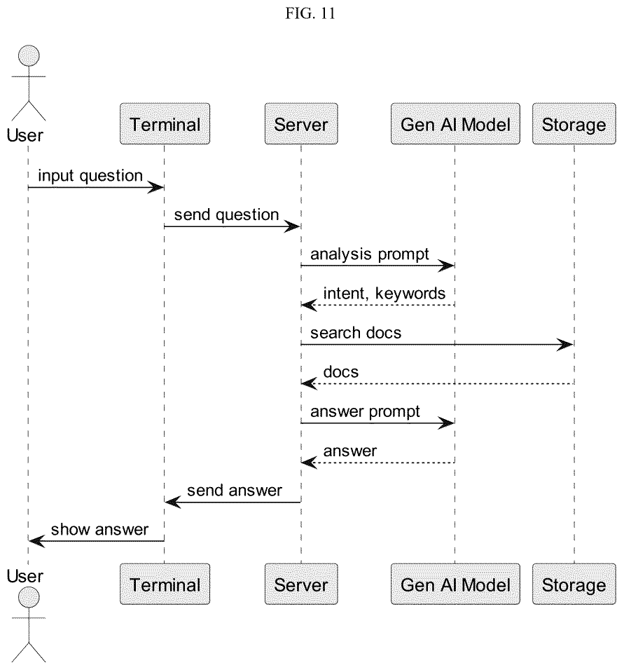

The following describes the processing flow using FIG. 11.

### Step 1:

User operates the terminal to input a natural-language question.

Terminal receives, as input, a character string entered via a keyboard or touch display, for example “How long is the battery life of the new product?”. Terminal removes leading and trailing whitespace, verifies that the length of the string is greater than zero, and encodes the string into a predefined character encoding such as UTF-8. Terminal then packages the encoded question together with a session identifier and a language code into interface data and outputs this interface data to the server via a network request.

### Step 2:

Server receives the interface data from the terminal.

Server takes, as input, the network packet containing the interface data, decodes the transport and application protocol headers, and parses the body to extract the question text, the session identifier, and the language code. Server stores these values in a question record in main memory, where the question field contains the raw text string. Server outputs the populated question record as an internal data structure for downstream processing.

### Step 3:

Server performs normalization and tokenization of the natural-language question.

Server receives, as input, the question record containing the raw question text. Server converts the text into a normalized form by applying lowercasing, Unicode normalization, and removal of control characters. Server then applies a tokenizer, such as a subword tokenizer associated with the generative AI model, to map the normalized text to a sequence of token identifiers. Server stores the normalized text and token sequence in additional fields of the question record and outputs the updated question record containing both the original and processed representations.

### Step 4:

Server constructs an analysis prompt sentence for intent and keyword extraction.

Server receives, as input, the normalized question text from the question record. Server selects a predefined analysis prompt template and inserts the question into a placeholder within the template. For example, server constructs the following prompt sentence as output:
Identify the main intent and important terms of the following question.
Question: “How long is the battery life of the new product?”
Output format:
Intent: [description of intent]
Keywords: [comma-separated list of important terms]

Server stores this analysis prompt sentence as a string field in an analysis-prompt object and outputs the analysis-prompt object for model inference.

### Step 5:

Server invokes the generative AI model to extract intent and important terms.

Server receives, as input, the analysis-prompt object containing the analysis prompt sentence.

Server tokenizes the prompt sentence into a sequence of token identifiers, arranges these tokens in an input tensor, and sends the tensor to the generative AI model, which is a transformer-based neural network hosted locally or remotely. The generative AI model processes the tensor using multi-head attention and feed-forward computations and outputs a sequence of output token identifiers representing generated text. Server decodes the output tokens into a text string such as:
Intent: ask about typical operating duration of a new product's battery.
Keywords: battery life, new product.

Server parses this text to extract the intent phrase and the list of important terms, then stores these values as structured fields in the question record. Server outputs the updated question record containing intent and important terms.

### Step 6:

Server generates a search request to the external storage service.

Server takes, as input, the intent and important terms stored in the question record. Server performs stemming and synonym expansion on each important term using a term dictionary, and constructs a query object that includes weighted search tokens linked by logical operators. For example, server may create a query such as (“battery life” AND “new product”) with higher weight for “battery life”. Server serializes the query object into a query string format supported by the external storage service and outputs a search request message to that service.

### Step 7:

Server retrieves relevant documents from the external storage service.

Server receives, as input, a search response from the external storage service that contains document identifiers ranked by relevance, based on indexed term statistics. Server selects a subset of document identifiers according to a cutoff rank or score threshold and issues document retrieval requests for each selected identifier. External storage returns the raw document data (for example, text, markup, or page-description content) to the server. Server decodes each document, extracts the main text content, and stores the content along with document metadata into a document list in memory. Server outputs this document list for further segmentation and scoring.

### Step 8:

Server segments documents into text segments and computes embeddings.

Server receives, as input, the document list containing plain text content and metadata. Server divides each document text into text segments, such as sentences or fixed-length windows of tokens, and labels each segment with its document identifier and position index. For each segment, server uses an embedding model, for example a transformer encoder, to convert the segment text into an embedding vector. Server also computes an embedding vector for the normalized question text. Server stores all segment embeddings and the question embedding in an embedding table and outputs a context-candidate set comprising segment identifiers and their embedding vectors.

### Step 9:

Server computes relevance scores and selects context segments.

Server takes, as input, the context-candidate set and the question embedding. For each segment embedding, server computes a similarity value with the question embedding, for example cosine similarity, and may combine this similarity with structural signals such as proximity to headings containing important terms. Server assigns a relevance score to each segment and writes the score into the context-candidate set. Server then sorts the segments by relevance score and selects the top segments above a predetermined threshold or within a fixed top-N limit. Server outputs a context set that includes only the selected segment texts, their identifiers, and their relevance scores.

### Step 10:

Server categorizes segments using clustering and category labels.

Server receives, as input, the context set and their embedding vectors. Server applies a clustering algorithm, such as k-means clustering, to group segment embeddings into clusters that correspond to topical categories. Server assigns a category identifier to each segment according to its cluster membership and stores category labels in the context set. Server may additionally map clusters to semantic labels, such as “specification,” “usage instructions,” or “troubleshooting,” based on representative terms. Server outputs an enriched context set where each segment has both a relevance score and a category identifier.

### Step 11:

Server constructs an answer-generation prompt sentence using question and context.

Server takes, as input, the normalized question text and the enriched context set. Server orders the selected text segments by a combination of relevance score and category priority, for example prioritizing segments in a “specification” category for technical parameter questions. Server selects a subset of segments that satisfies a maximum token budget for the generative AI model. Server then inserts the question and the selected segments into an answer template, and outputs an answer-generation prompt sentence such as: You are an assistant that answers user questions based only on the provided context.

Question: “How long is the battery life of the new product?”

### Context:

1. “Battery life: approx. 10 hours under normal usage conditions.”
2. “Charging time: about 2 hours for a full charge.”

### Instruction:

Use only the information in the Context.
If the answer is not clearly stated, say that the information is not available.

### Output Format:

Question: [user's question]
Answer: [concise answer]

Server stores this answer-generation prompt sentence in a prompt object and outputs the prompt object.

### Step 12:

Server invokes the generative AI model to generate an answer sentence.

Server receives, as input, the prompt object containing the answer-generation prompt sentence. Server tokenizes the prompt sentence into tokens, constructs an input tensor, and provides this tensor to the generative AI model configured for text generation. The model computes next-token probability distributions conditioned on the prompt and iteratively samples or selects tokens to form an output sequence. Server decodes the generated tokens into natural-language text, which includes an answer formatted according to the requested “Question:” and “Answer:” lines. Server examines the generated text, verifies that it follows the output format, and extracts the answer sentence. Server outputs the answer sentence along with references to the source segments used in the prompt.

### Step 13:

Server formats the response data for transmission to the terminal.

Server takes, as input, the answer sentence, the original question, and identifiers of the source documents and segments. Server constructs a response data structure that includes the question, the answer, and optional metadata such as source document identifiers and confidence indicators. Server serializes this structure into a response message suitable for the communication protocol, sets appropriate headers, and outputs the response message to the terminal over the network.

### Step 14:

Terminal receives and displays the response to the user.

Terminal receives, as input, the response message from the server. Terminal decodes the message, parses the response data, and extracts at least the answer sentence and the corresponding question. Terminal updates the graphical user interface to display the answer in a visible area, optionally along with cited document references or categories. Terminal outputs the rendered content to the display hardware so that the user can read the answer and, if desired, input a follow-up question.

### Step 15:

Server estimates the user's emotional state and adjusts future processing.

Server receives, as input, interaction data such as the sequence of questions, timing between requests, length of questions, and any sentiment indicators detected in the user's text. Server constructs a feature vector from these inputs and applies an emotion-classification model to produce an estimated emotional state label. Server stores the emotional-state label in association with the session and uses it as input when generating subsequent search requests and prompt sentences, for example by adjusting the number of context segments, the desired answer length, or the level of explanation requested in the prompt. Server outputs updated configuration parameters that influence later steps, thereby adapting the processing flow for future queries from the same user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information provision systems in physical or online retail environments typically rely on keyword-based search or static question-answer pairs. Such systems require a user to know specific product names, technical terms, or document identifiers, and are therefore poorly suited for handling ambiguous or conversational natural-language questions. When a user asks a question in everyday language, existing systems often fail to correctly detect the user's intent, retrieve the most relevant product information, or generate an answer that is both accurate and contextually appropriate.

Furthermore, in many deployments, different functional components—such as natural-language processing, access to remote storage services, automatic classification, generative AI models, emotion estimation, autocomplete, and machine translation—are implemented as isolated modules without an integrated orchestration mechanism. As a result, the overall system exhibits high latency, inconsistent use of context, and duplicated computation. For example, a question may be analyzed separately for search, for classification, and for answer generation, leading to redundant parsing and feature extraction. This fragmented processing reduces system throughput and limits the scalability of the service.

In addition, conventional systems generally do not enforce a tight coupling between the authoritative data retrieved from a storage service and the output of a generative AI model. When a generative AI model is used, the model is often prompted in an ad hoc way that does not explicitly constrain the model to remain faithful to the retrieved information. This can lead to hallucinated or outdated answers, which are particularly problematic in domains such as warranty conditions, return policies, and product specifications where factual accuracy and traceability to source documents are required.

Another technical problem is that most existing systems either ignore the emotional state of the user or treat it only at a superficial level in the user interface, without integrating emotion estimation into the core retrieval and generation pipeline. As a consequence, the system cannot dynamically adapt the level of detail, tone, or autocomplete prioritization based on the user's frustration, confusion, or confidence, which leads to suboptimal user-system interaction and inefficient resolution of user queries.

Multilingual scenarios also expose limitations of conventional architectures. When users, stored documents, and answer outputs use different languages, many systems perform translation in a piecemeal manner, translating only at the user interface layer or only at the document layer. This fragmented translation flow causes inconsistencies between the language used for intent interpretation, retrieval, and answer generation, and can degrade both retrieval precision and answer quality.

Accordingly, there is a need for an improved computer-implemented system and server-side processing architecture that: (i) unifies natural-language understanding, retrieval from remote storage, automatic categorization, and answer generation into a single coordinated pipeline; (ii) systematically incorporates generative AI models via structured prompt sentences that encode explicit constraints based on retrieved authoritative data; (iii) integrates emotion estimation into query handling, autocomplete ranking, and answer formatting; and (iv) consistently manages multilingual processing so that question analysis, document retrieval, and answer generation operate coherently across languages. Such improvements are directed to enhancing the functioning of the computer system itself, including reduced redundant computation, improved resource utilization, improved response accuracy, and more adaptive interaction behavior.

The specific processing by the specific processing unit 290 of the data processing device 12 in Application Example 1 is realized by the following means.

The present invention provides a server comprising a processor configured to receive inquiry data including a natural-language question, terminal identification information, and language information from a terminal, to analyze the natural-language question using a natural-language processing algorithm that performs morphological analysis, syntactic analysis, and named-entity extraction to obtain topic-indicating expressions, product identification information, and category candidates, to construct structured prompt sentences that explicitly encode the question, the topic-indicating expressions, the category candidates, and constraint conditions preserving contents of related information, and to supply the structured prompt sentences to a generative information processing algorithm so as to obtain intent information, category information, and a natural-language answer sentence that are constrained by the related information acquired from a network-accessible storage device.

This enables the server to implement an integrated, computer-implemented pipeline in which natural-language understanding, remote storage retrieval, automatic categorization, generative answer synthesis, emotion-aware adaptation of responses and autocomplete priorities, and multilingual translation are orchestrated as a unified sequence of processing steps, thereby improving the overall functioning of the computer system in terms of retrieval accuracy, consistency between authoritative data and generated answers, computational efficiency, and adaptability of the user interaction.

The term “processor” refers to one or more hardware computation units, such as a central processing unit or an execution core, configured to execute machine-readable instructions that implement the functions described in the claims.

The term “terminal” refers to an information processing apparatus including at least a display device and an input device, and configured to transmit inquiry data to the server and to present answer information to a user.

The term “display device” refers to a visual output component, such as a screen or monitor, capable of presenting text and graphical information generated by the terminal or the server.

The term “input device” refers to a user interface component, such as a keyboard, touch panel, pointing device, or microphone, configured to receive operation inputs or question inputs from a user.

The term “inquiry data” refers to structured data transmitted from the terminal to the server, including at least a natural-language question, terminal identification information, and language information.

The term “natural-language question” refers to a string of characters or speech-derived text expressed in a human language used in daily communication and representing a user's request for information.

The term “terminal identification information” refers to data that uniquely or quasi-uniquely identifies a terminal, such as a terminal ID, network address, or session identifier, and is used for managing communication or context.

The term “language information” refers to data indicating a language associated with the inquiry, such as a language code or locale, and is used to control analysis, retrieval, or translation processing.

The term “natural-language processing algorithm” refers to a software-implemented procedure that performs linguistic analysis operations, including at least morphological analysis, syntactic analysis, and named-entity extraction, on a natural-language question.

The term “morphological analysis” refers to processing that segments a natural-language text into word-level or morpheme-level units and assigns grammatical or lexical attributes to the units.

The term “syntactic analysis” refers to processing that determines syntactic relations among words or morphemes, including at least dependency relations or phrase structure, in a natural-language text.

The term “named-entity extraction” refers to processing that detects and labels specific expressions in a text, such as names of products, organizations, locations, or dates, as entity types.

The term “topic-indicating expressions” refers to words or phrases extracted from a question that represent a main subject or theme of the question, such as warranty, return policy, or specifications.

The term “product identification information” refers to data indicating a target product or item, such as a product code, model identifier, or category identifier, derived from the question or associated context.

The term “category candidates” refers to one or more inferred classifications, such as semantic or functional categories, that are estimated from a question and are used as inputs to retrieval or answer generation.

The term “generative information processing algorithm” refers to a machine-learned model or rule-based generator configured to produce new natural-language text, including at least an interpretation of user intent and a generated answer sentence, based on input prompt sentences.

The term “prompt sentence” refers to a structured natural-language or machine-readable text that encapsulates a question, contextual information, constraint conditions, or instructions, and is provided as input to a generative information processing algorithm.

The term “intent information” refers to data representing an interpreted purpose or objective of a user's question as determined by a generative information processing algorithm or other analysis components.

The term “category information” refers to data indicating one or more categories assigned to a question or to related information, and is used to guide retrieval, classification, or answer generation.

The term “storage device” refers to a remote or local data storage apparatus, such as a network-accessible storage system, that stores product information, description information, regulation information, and other related data.

The term “product information” refers to data describing properties of a product, including at least specifications, functions, and usage-related details.

The term “description information” refers to textual or structured explanatory data that describes products, services, or policies in a human-readable form.

The term “regulation information” refers to data describing rules, terms, or conditions applicable to products or services, such as warranty terms or return conditions.

The term “related information” refers to information selected or retrieved from the storage device based on a search condition associated with a user's question and deemed relevant to answering the question.

The term “information category hierarchy” refers to a predefined structure of categories and subcategories that classifies information at multiple hierarchical levels for organization and retrieval.

The term “machine-learning algorithm” refers to a computational method that adjusts internal parameters based on training data to perform tasks such as classification, prediction, or clustering of information.

The term “higher-level categories” refers to abstract or general categories, positioned at an upper level in the information category hierarchy, such as warranty information, return conditions, usage information, specification information, and store policy information.

The term “warranty information” refers to data describing conditions under which a product is repaired, replaced, or supported, including warranty period, coverage, and limitations.

The term “return conditions” refers to data describing policies and constraints for returning or exchanging products, including time limits, required documentation, and product state requirements.

The term “usage information” refers to data describing how to operate or use a product or service, including instructions, procedures, and cautions.

The term “specification information” refers to data describing technical or functional attributes of a product, such as dimensions, performance characteristics, or interface requirements.

The term “store policy information” refers to data describing operational rules, guidelines, or policies of a retail environment, such as payment methods, delivery options, or service terms.

The term “constraint conditions” refers to parameters or instructions included in a prompt sentence that limit or guide a generative information processing algorithm so that generated text remains consistent with specified related information.

The term “natural-language answer sentence” refers to a response expressed in a human language, generated or formatted by the system, that addresses the user's question.

The term “emotion estimation algorithm” refers to a computational method that infers an emotional state of a user, such as satisfaction, confusion, or frustration, from inputs including at least textual content, behavioral signals, or interaction context.

The term “emotional state” refers to an internal affective condition of a user estimated by the emotion estimation algorithm and used to adapt responses or interaction behavior.

The term “supplementary information” refers to additional explanatory content, such as detailed descriptions, examples, or references, that is provided alongside a primary answer.

The term “completion candidates” refers to one or more prediction strings proposed as continuations or completions of a partially input question sentence in an autocomplete interface.

The term “machine translation algorithm” refers to a computational method configured to automatically convert text from one natural language into another natural language.

The term “desired language of the user” refers to a natural language indicated by the user or inferred from user or terminal settings, and used as a target language for answer presentation or translation.

The term “identification information of the related information” refers to data that uniquely or quasi-uniquely identifies related information used in generating an answer, such as a document identifier, path, or record key.

In one embodiment, a server cooperates with one or more terminals to implement the claimed system. The server includes at least one processor, a main memory, a non-volatile storage device, and a network interface. The terminal includes a display device, an input device such as a touch panel or keyboard, a local processor, and a communication interface. The server and the terminal communicate via a communication network such as a wired or wireless packet network using a protocol such as HTTPS.

The server executes an operating system such as a general-purpose server operating system and runs an application implemented, for example, in a programming language such as Python. The server uses a natural-language processing library such as spaCy, a network-accessible storage service client such as a cloud storage API client, and a generative AI model interface such as an API client to a large-scale neural network model. The generative AI model is implemented as a multi-layer neural network, for example a transformer-based architecture having an embedding layer, a plurality of self-attention layers, feed-forward layers, and an output layer that generates tokens representing natural-language text.

The server stores, in the non-volatile storage device or in the network-accessible storage device, product information, description information, regulation information, and category information. The server stores these data as structured data, for example, in a document-oriented structure including fields such as product identifier, category label, warranty period, return conditions, usage instructions, specification parameters, and store policy descriptions.

The server further stores an information category hierarchy as a tree structure defining higher-level categories such as warranty information, return conditions, usage information, specification information, and store policy information, and mapping rules between low-level document fields and higher-level categories.

The terminal presents, on the display device, a user interface that includes a text input field for a natural-language question, optional selection fields for a product or category, and an area for displaying answers. The terminal sends, to the server, inquiry data that includes at least the text of the natural-language question, a terminal identification value, a session identifier, and language information indicating a preferred language of the user. The terminal receives, from the server, answer sentences and related metadata, and the terminal renders the answer sentences and optionally links or indicators for related source information on the display device.

The server uses the natural-language processing library to perform morphological analysis, syntactic analysis, and named-entity extraction on the received question text. The server represents the question as a sequence of tokens, each token having attributes such as lemma, part-of-speech tag, dependency relation, and character offset. The server determines topic-indicating expressions by applying rules that select noun phrases, verb-object combinations, and domain-specific terms from the tokens. For example, when the user asks “How long is the warranty period for this product?”, the server identifies “warranty period” as a topic-indicating expression, and, if present, extracts a product identifier from recognized entity tokens.

The server stores, in memory, a mapping between linguistic patterns and internal category candidates. The server uses this mapping to convert topic-indicating expressions such as “warranty period”, “guarantee length”, or “how long is the guarantee” into a common category candidate representing warranty-related information. This mapping uses rule-based pattern matching that is not limited to direct keyword equality but also considers morphological normalization and synonym groups, thereby reducing ambiguity and improving category assignment accuracy.

The server configures the generative AI model as a transformer-based neural network trained on large amounts of text data and fine-tuned using domain-specific examples. The server uses an optimization algorithm such as Adam during training, and defines a loss function such as cross-entropy between predicted token distributions and reference tokens. The server updates the weights of the neural network by backpropagation, and may apply regularization techniques such as dropout and layer normalization to stabilize training and prevent overfitting. The server, in some embodiments, performs data augmentation by paraphrasing training questions or by inserting synthetic noise to make the model robust to variation in user input.

The server generates a prompt sentence to be input to the generative AI model. The server constructs the prompt sentence as a structured text that includes the user's question, intermediate analysis results such as topic-indicating expressions and category candidates, and explicit instructions to the model to output intent information and category information in a machine-readable format. For example, the server constructs a prompt sentence such as:
“User question: ‘How long is the warranty period for this product?’
Extracted topic: ‘warranty period’
Task: Identify the user's intent and the most relevant category.
Output the result in the form: INTENT: <intent description>; CATEGORY: <category label>”

The server thus uses the generative AI model not as a black box, but as a structured component that outputs specific intent and category labels according to explicit constraints encoded in the prompt sentence. This structured prompting improves the determinism and interpretability of the model's outputs and reduces the occurrence of irrelevant interpretations.

The server uses the intent information and category information output from the generative AI model to generate a search condition for the storage device. The server composes a search query that includes a product identifier, a category label, and potentially additional filters such as language code or document version. The server then uses a storage service client, for example a cloud storage API client, to access a bucket or collection storing product-related documents. The server applies path patterns or metadata filters to identify documents relevant to the given product and category.

The server retrieves one or more documents from the storage device and parses them into structured representations. For text documents, the server may convert them to plain text and associate segments with headings or structural markers (for example, “Warranty”, “Return Policy”, “Specifications”). For JSON documents, the server reads values of relevant keys such as “warranty_period”, “conditions”, or “return_window”. The server calculates similarity scores between the question representation and each candidate document or segment using, for instance, cosine similarity over vector embeddings or weighted keyword match counts. The server selects one or more segments with the highest scores as related information.

The server performs automatic classification of the acquired related information into the information category hierarchy. The server uses features such as term frequency-inverse document frequency (TF-IDF) values, presence of domain-specific terms, structural positions within documents, and metadata fields. The server feeds these features into a machine-learning classifier, for example a neural network classifier or a gradient-boosting model, trained to output a probability distribution over the higher-level categories. By classifying related information to higher-level categories, the server can standardize heterogeneous data sources and support consistent answer generation across different types of products and documents.

The server constructs another prompt sentence for the generative AI model to generate a final natural-language answer. The server embeds, in the prompt sentence, the user's original question, the selected related information, and explicit constraint conditions directing the model to remain faithful to the related information and to avoid fabricating unsupported details. For example, the server may construct:
“User question: ‘How long is the warranty period for this product?’
Relevant information from the database: ‘For Product A, the warranty period is 2 years from the date of purchase. The warranty covers manufacturing defects only.’
Instruction: Using only the relevant information above, answer the user's question clearly and concisely in one or two sentences. Do not introduce any information that is not supported by the relevant information.”

By formulating the prompt sentence in this way, the server reduces the likelihood that the generative AI model will output incorrect or hallucinated information. This configuration improves technical reliability of the system compared to simple free-form generation.

The server optionally applies a translation algorithm when the language of the question, the language of the related information, and the preferred language of the user differ. The server may use a machine translation model such as a sequence-to-sequence neural network with attention mechanisms. The server applies translation at consistent points in the pipeline, for example translating the user's question into a processing language for analysis and then translating the final answer sentence into the user's preferred language, maintaining a stable internal representation language. This structured translation flow reduces inconsistencies and improves both retrieval and answer quality in multilingual environments.

The server implements an emotion estimation module that analyzes the question text and, in some embodiments, additional signals such as interaction history or timing. The server uses features such as sentiment polarity scores, occurrence of frustration-related terms, and question repetition patterns. The server inputs these features into a classification model, for example a neural network or support vector machine, that outputs an estimated emotional state, such as neutral, confused, or frustrated. The server uses the estimated emotional state to adjust the length, tone, and detail level of the answer, as well as the ordering of autocomplete suggestions. For example, when the user is estimated to be confused, the server may prioritize more explicit and step-by-step explanations and suppress overly technical terms.

The server maintains an autocomplete index of frequent questions, product names, and policy-related phrases. The server updates the index based on historical queries and retrieved answers. When the user partially inputs a question at the terminal, the terminal may send the partial text to the server. The server generates completion candidates using the index and ranks them according to a scoring function that considers the partial input, topic-indicating expressions, and the estimated emotional state. The server returns a list of completion candidates, and the terminal displays them as suggestions. This behavior reduces input time and helps users formulate questions that the system can handle effectively, thereby improving interaction efficiency.

The server, by orchestrating natural-language processing, generative AI inference, storage retrieval, automatic classification, emotion estimation, autocomplete ranking, and machine translation in a coordinated manner, improves the functioning of the underlying computer system. The server reduces redundant computations by reusing the same parsed representation of the question across modules. The server decreases response time by caching frequently used model parameters and pre-loading category mappings. The server increases answer accuracy by constraining generative outputs using retrieved structured data. The server enhances data management by classifying documents into an explicit category hierarchy. These improvements go beyond mere automation of human clerical tasks and instead modify how the computer processes and routes data in a technically advantageous way.

In another embodiment, the server uses an alternative generative AI model, such as a smaller transformer model executed on-premises, for environments with limited network connectivity. The server may dynamically select between a cloud-hosted model and a local model based on current network latency and load, thereby optimizing response time and resource utilization. In yet another embodiment, the server replaces or supplements the generative AI model with a template-based answer generation module for certain categories, while still using the generative AI model for intent interpretation and complex explanations. This modular design allows the server to achieve predictable behavior for highly regulated content (for example, legal terms) while benefiting from the flexibility of generative models in other contexts.

The server, in some embodiments, uses different neural network architectures or training strategies for the intent interpretation task and the answer generation task. The server may use a classifier network that outputs intent and category labels given an embedding of the question and, separately, a generative model that produces answer sentences. The server trains the classifier using labeled examples of questions and categories and uses a loss function such as cross-entropy. The server trains the generative model using pairs of question-context and answer sentences. By decoupling classification and generation, the server can optimize each model for its specific objective and can update one model independently of the other.

The terminal may be implemented as a handheld device, a kiosk in a physical store, or a general-purpose computing device. The terminal provides not only a text interface but also, in some embodiments, a voice interface. The terminal may capture speech audio, convert it to text using a speech recognition engine, and then send the recognized text as a natural-language question to the server. The terminal may display the answer both as text and as synthesized speech. This configuration allows the disclosed system to be deployed directly in physical environments where users interact with an actual device that provides immediate, context-sensitive information about products and services.

The user interacts with the terminal in a natural manner, asking questions such as “How long is the warranty period for this product?” or “Please explain the return policy for this television.” The server processes these questions using the described architecture and returns concise, accurate answers bound to authoritative documents stored in the storage device. As a result, the user can obtain reliable information quickly, and the underlying computer system achieves improved technical performance in terms of response time, accuracy, and robustness compared to conventional keyword-based or ad hoc generative systems.

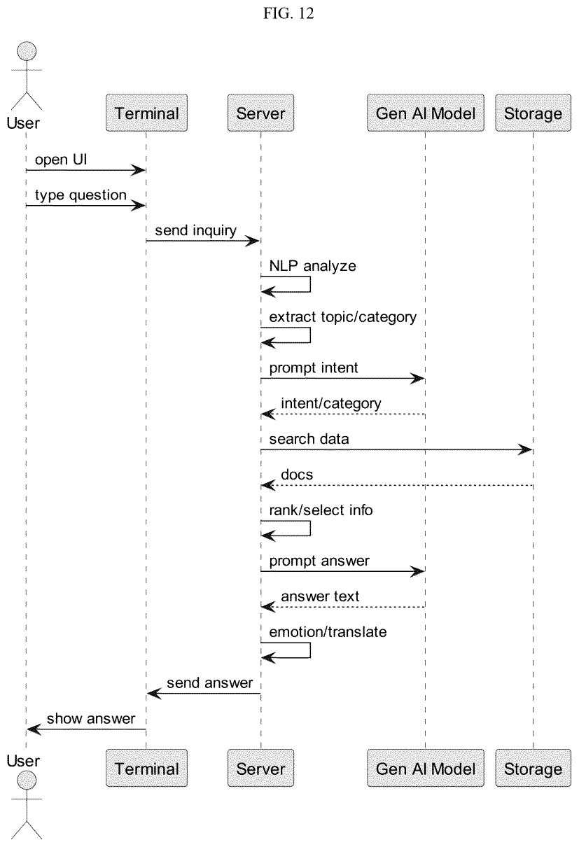

The following describes the processing flow using FIG. 12.

### Step 1:

The user operates the terminal to open an information inquiry screen.

The terminal displays a user interface including a text input field and, optionally, product selection controls.

The input to this step is the terminal's UI configuration and any previously stored session information, and the output is a rendered screen that is ready to accept a natural-language question from the user.

### Step 2:

The user inputs a natural-language question via the terminal, for example using a touch keyboard or physical keyboard.

The terminal captures the question text, associates it with a terminal identifier, a session identifier, and language information, and forms inquiry data.

The input to this step is the user's keystrokes or speech-recognized text, and the output is a structured data object containing at least the question text, terminal ID, session ID, and language code.

### Step 3:

The terminal transmits the inquiry data to the server through a secure communication channel such as HTTPS.

The terminal performs serialization of the inquiry data into a message format, for example JSON over HTTP, and sends it to a predefined API endpoint.

The input to this step is the structured inquiry data, and the output is an HTTP request message delivered to the server.

### Step 4:

The server receives the HTTP request using a web application framework and parses the request body.

The server verifies the integrity of the message, extracts the question text, terminal identification information, session information, and language information, and stores these values in memory for further processing.

The input to this step is the HTTP request message, and the output is an internal representation of the inquiry data as variables or objects in server memory.

### Step 5:

The server performs initial preprocessing of the question text.

The server normalizes the text by, for example, converting character case, standardizing whitespace, and optionally removing control characters; the server may also perform language detection if multiple processing languages are supported.

The input to this step is the raw question string, and the output is a cleaned, normalized question string and, where applicable, a determined processing language.

### Step 6:

The server applies a natural-language processing library such as spaCy to analyze the normalized question text.

The server tokenizes the text into words or morphemes, assigns part-of-speech tags, computes dependency relations, and performs named-entity recognition.

The input to this step is the normalized question string, and the output is a linguistic analysis structure, including a list of tokens with attributes and a list of detected named entities.

### Step 7:

The server extracts topic-indicating expressions, product identification information, and category candidates from the linguistic analysis structure.

The server runs rule-based pattern matching and dictionary lookup on the tokens and entities, groups relevant tokens into noun phrases or verb-object pairs, and maps certain expressions to internal category labels, such as warranty-related or return-related categories.

The input to this step is the linguistic analysis structure, and the output is a set of topic-indicating phrases, a product identifier (if detected), and one or more category candidates.

### Step 8:

The server constructs a first prompt sentence for intent interpretation by a generative AI model.

The server concatenates the original question, the extracted topic-indicating expressions, and explicit instructions into a structured text, while specifying a required output format for intent and category labels.

The input to this step is the question text, the topic-indicating expressions, and the category candidates, and the output is a prompt sentence configured to elicit intent information and category information from the generative AI model.

### Step 9:

The server sends the first prompt sentence to the generative AI model through an API client.

The server forms a request that includes the prompt sentence and generation parameters such as maximum token count and temperature, and transmits this request to the model execution environment.

The input to this step is the structured prompt sentence, and the output is an API call carrying the prompt to the generative AI model.

### Step 10:

The server receives a response from the generative AI model representing interpreted intent and category information.

The server parses the model output according to the predefined format specified in the prompt, extracts an intent description and one or more category labels, and performs basic consistency checks on the values.

The input to this step is the raw text or structured output from the generative AI model, and the output is a normalized intent information object and normalized category information.

### Step 11:

The server generates a search condition for a storage device based on the intent information, category information, and product identification information.

The server creates a query structure that includes fields such as product ID, category label, and language code, and maps these fields to storage locations or metadata filters (for example, paths, tags, or field names) used in the network-accessible storage service.

The input to this step is the intent information, category information, and product identifier, and the output is a storage query object that defines how to search for related information.

### Step 12:

The server accesses the storage device via a storage service client and executes the search condition.

The server sends list and get requests to the storage service, scans matching objects or records, and retrieves documents that match the product and category filters.

The input to this step is the storage query object, and the output is a collection of candidate documents or document segments retrieved from the storage device.

### Step 13:

The server parses the retrieved documents into structured content units.

The server converts document formats (for example, text files, structured documents, or records) into a unified internal representation, segments texts into sections such as warranty clauses or return policies, and associates each segment with metadata including source identifier and category tags.

The input to this step is the collection of retrieved documents, and the output is a structured set of content segments with associated metadata.

### Step 14:

The server evaluates the relevance of each content segment with respect to the user's question.

The server computes features such as keyword overlap between the question and the segment, similarity scores using vector embeddings, and alignment between the segment's category label and the user's inferred category; the server then assigns a relevance score and ranks the segments.

The input to this step is the question representation and the structured content segments, and the output is a ranked list of content segments with relevance scores.

### Step 15:

The server performs automatic classification of the highly ranked content segments into higher-level categories.

The server computes feature vectors based on term statistics, structural positions, and metadata, and applies a machine-learning classifier to assign probabilities to categories such as warranty information, return conditions, usage information, specification information, and store policy information.

The input to this step is the set of content segments with relevance scores, and the output is the same segments annotated with higher-level category labels and classification confidence values.

### Step 16:

The server selects one or more most relevant content segments as related information for answer generation.

The server applies a threshold or top-k selection on the ranked, classified segments and concatenates or aggregates the text contents of the selected segments into a context text. The input to this step is the category-annotated and ranked segments, and the output is a context text representing the related information and a list of identifiers for the source segments.

### Step 17:

The server constructs a second prompt sentence for answer generation by the generative AI model.

The server embeds the original question, the context text, and explicit constraint instructions, such as “use only the provided information” and “do not introduce unsupported details,” into a single textual prompt specifying the desired style, length, and language of the answer.

The input to this step is the original question and the context text, and the output is a prompt sentence configured to guide the generative AI model in producing a constrained natural-language answer sentence.

### Step 18:

The server sends the second prompt sentence to the generative AI model and requests generation of an answer sentence.

The server forms an API request that includes the prompt sentence and generation parameters (for example, maximum answer length and target language), and transmits this request to the model execution environment.

The input to this step is the second prompt sentence, and the output is an API call initiating answer generation by the generative AI model.

### Step 19:

The server receives a generated answer sentence from the generative AI model and performs validation and post-processing.

The server checks whether key factual values appearing in the answer (for example, warranty duration or return period) are consistent with the context text, optionally replacing or correcting inconsistent portions, and may adjust formatting such as sentence boundaries or punctuation.

The input to this step is the raw generated text from the generative AI model and the context text, and the output is a validated and formatted natural-language answer sentence.

### Step 20:

The server estimates an emotional state of the user based on the question text and interaction context.

The server computes features such as sentiment scores, presence of frustration-related terms, and question repetition counts; the server feeds these features into an emotion estimation model to obtain an emotional state label (for example, neutral, confused, or frustrated).

The input to this step is the question representation and interaction history, and the output is an emotional state estimate used to adapt subsequent processing.

### Step 21:

The server adapts the answer sentence and potential supplementary information based on the estimated emotional state.

The server adjusts parameters such as the level of detail, politeness markers, and inclusion of additional explanatory segments; for example, when the user appears confused, the server may append clarifying sentences or usage examples to the answer.

The input to this step is the generated answer sentence and the emotional state estimate, and the output is a modified answer sentence and, optionally, one or more supplementary explanations.

### Step 22:

The server, when necessary, performs language conversion on the answer sentence and related information.

The server compares the language of the generated answer and the user's preferred language; if different, the server applies a machine translation model to convert the answer and, optionally, short excerpts of related information into the preferred language.

The input to this step is the answer sentence, the related information text, and the preferred language code, and the output is a translated answer sentence and translated related information where applicable.

### Step 23:

The server assembles a response object for transmission to the terminal.

The server includes the final answer sentence, identifiers of the source documents or segments, and optionally the higher-level category label and language code, and serializes this data into a response message format.

The input to this step is the final answer sentence, source identifiers, and metadata, and the output is a structured response object ready to be sent over the network.

### Step 24:

The server transmits the response object to the terminal via the communication network.

The server encapsulates the response object in an HTTP response message and sends it to the terminal's API client endpoint.

The input to this step is the structured response object, and the output is an HTTP response delivered to the terminal.

### Step 25:

The terminal receives the HTTP response and parses the response body.

The terminal extracts the answer sentence, source identifiers, and metadata from the response, and prepares these values for display.

The input to this step is the HTTP response message, and the output is an internal representation of the answer data in the terminal's memory.

### Step 26:

The terminal displays the answer sentence and, optionally, related information indicators on the display device.

The terminal renders the answer text in a designated area of the user interface, may show a category label such as “Warranty” or “Return Policy,” and may provide a control for viewing more details from the source documents.

The input to this step is the parsed answer data, and the output is a visual presentation of the answer on the terminal's screen.

### Step 27:

The user reviews the displayed answer and may initiate a follow-up interaction.

The user reads the answer and, if additional clarification is required, inputs a new or refined natural-language question, which triggers repetition of the described processing sequence starting from the terminal's capture of the new question.

The input to this step is the displayed answer and the user's evaluation of its sufficiency, and the output is a new question input or an end of interaction.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional storage services, information resources such as documents, images, and other digital content are accumulated in large volumes without sufficient semantic organization. A processor of such conventional systems typically performs only simple keyword-based search or folder-based management. As a result, when the amount of stored information increases, it becomes increasingly difficult for the user to locate a desired information resource efficiently. In particular, conventional systems exhibit several technical limitations.

First, conventional systems do not effectively leverage generative artificial intelligence models and natural language processing algorithms in an integrated manner. Natural language queries from the user are often processed by simple parsing or fixed rule-based logic, which fails to accurately capture the intention of the user in many cases. This leads to search results that are irrelevant or incomplete, increasing the processing load on the user and degrading the overall usability of the storage service.

Second, existing classification mechanisms generally rely on manually defined tags or static category rules. These mechanisms are not designed to incorporate deep semantic analysis of text data within stored information resources, nor to integrate category proposals generated by a generative artificial intelligence model. Consequently, stored information resources are not automatically and consistently classified according to a predefined classification scheme, and the underlying data structures and indices of the storage service are not optimized for semantic retrieval.

Third, conventional systems do not dynamically adjust search result presentation, autocomplete suggestions, or related user interface elements based on an estimated emotional state of the user. Without such adjustment, the system cannot modify its response behavior in real time to reduce cognitive load or frustration when the user is confused, impatient, or otherwise in a particular emotional state, thereby limiting the effectiveness and responsiveness of the human-computer interaction.

Fourth, when information resources are stored in multiple languages, conventional systems typically require manual selection of translation tools or external applications. There is no unified processing pipeline in which a processor automatically applies machine translation algorithms to multi-language content within the storage service and presents the translated information in the user's preferred language. This lack of integration increases latency, complicates internal processing, and prevents efficient cross-language search and classification at the system level.

Therefore, there is a need for a computer-implemented technique that improves the internal operation of a storage service by (i) accurately capturing a user's intention from a natural language query using a generative artificial intelligence model, (ii) performing advanced semantic analysis and automatic classification of stored information resources using natural language processing algorithms and category proposals from the generative artificial intelligence model, (iii) adjusting search result presentation and autocomplete behavior based on an estimated emotional state of the user, and (iv) automatically translating multi-language information resources using a machine translation algorithm. Such a technique should enhance the efficiency, accuracy, and responsiveness of the storage service at the level of processor configuration, data structures, and algorithmic processing, thereby improving the computer technology underlying storage management and retrieval.

The specific processing by the specific processing unit 290 of the data processing device 12 in Example 2 is realized by the following means.

The present invention provides a server comprising a processor configured to receive, from a terminal operated by a user, an access request for acquiring an information resource stored in a storage service; to receive, from the user, a natural language query related to the access request; to analyze the natural language query; to generate a prompt sentence for causing a generative artificial intelligence model to understand an intention of the query; to input the prompt sentence to the generative artificial intelligence model and obtain intention information from the generative artificial intelligence model; to execute a search process on information resources stored in the storage service based on the intention information; to extract a related information resource and derive response information; to extract text data from an information resource stored in the storage service or from the extracted information resource; to analyze the text data using a natural language processing algorithm to obtain keyword information or topic information; to automatically classify the information resource into a category according to a predefined classification scheme based on the keyword information or the topic information, and to record category information in association with the information resource; to input, to the generative artificial intelligence model, a prompt sentence including the text data and an analysis result of the natural language processing algorithm; to obtain category information proposed by the generative artificial intelligence model and correct or select the proposed category information so as to be consistent with a category in the predefined classification scheme; to estimate an emotional state of the user based on an input behavior or response content of the user, and adjust at least one of a presentation order of search results and candidate information for autocomplete based on the emotional state; to execute, for an information resource stored in the storage service and described in a different language, an automatic translation process using a machine translation algorithm, and present the translated information resource in a usage language of the user; and to generate a notification message for notifying the user of category information of the information resource automatically classified and transmit the notification message to the terminal via a communication line. This enables the storage service to internally process natural language queries and stored information resources in a unified pipeline that combines generative artificial intelligence models, natural language processing algorithms, automatic classification logic, emotional-state-adaptive presentation control, and machine translation algorithms, thereby improving the efficiency, accuracy, and responsiveness of computer operations for information retrieval, classification, and presentation within the storage system.

The term “system” refers to an arrangement of one or more computing devices, storage devices, communication interfaces, and associated software components that cooperate to execute the processes described in the claims.

The term “processor” refers to one or more hardware processing units, such as a central processing unit, a graphics processing unit, or a specialized accelerator, configured by executable instructions to perform arithmetic, logical, control, and input/output operations for implementing the claimed functions.

The term “terminal” refers to an electronic device operated by a user, including but not limited to a personal computer, a tablet device, a smartphone, or any network-capable client device, that is configured to communicate with the system via a communication network.

The term “user” refers to a human operator or an entity that interacts with the system through a terminal to issue queries, upload or access information resources, and receive responses or notifications.

The term “storage service” refers to a computer-implemented service that stores, manages, and provides access to information resources over a communication network, including cloud-based storage systems and on-premises storage systems.

The term “information resource” refers to any digital content item stored in the storage service, including, but not limited to, files, documents, images, media data, and associated metadata.

The term “access request” refers to a request transmitted from a terminal to the system for performing an operation on an information resource, such as uploading, downloading, searching, or retrieving the information resource.

The term “natural language query” refers to a query expressed in a human language, such as a sentence or phrase, that is provided by the user for specifying an information need or operation to be performed by the system.

The term “prompt sentence” refers to a sequence of characters or tokens, including instructions, context, and optionally document content, prepared by the processor and input to a generative artificial intelligence model to induce a desired output from the model.

The term “generative artificial intelligence model” refers to a machine learning model configured to generate text or other content in response to input data, including large language models and similar generative models capable of understanding and producing natural language.

The term “intention information” refers to structured data or semantic representation of the underlying purpose or goal inferred from a natural language query by the generative artificial intelligence model and used by the processor to control search and other operations.

The term “search process” refers to a sequence of operations executed by the processor to locate one or more information resources in the storage service based on intention information, query content, or other search parameters.

The term “response information” refers to information generated by the processor as an answer or result to a natural language query, including references to information resources, extracted text, summaries, or explanations.

The term “text data” refers to a sequence of characters or linguistic tokens extracted from an information resource, including textual content within documents, embedded text in media, and associated descriptive metadata.

The term “natural language processing algorithm” refers to one or more software-implemented procedures that analyze text data, including tokenization, part-of-speech tagging, entity recognition, topic detection, key phrase extraction, or other linguistic or semantic analysis.

The term “keyword information” refers to one or more terms or phrases extracted from text data that are identified as salient or representative of the content of an information resource.

The term “topic information” refers to data representing one or more abstract topics or themes inferred from text data using a natural language processing algorithm or statistical model.

The term “predefined classification scheme” refers to a structured set of categories, labels, or classes defined in advance by a system administrator, application logic, or configuration data, used for organizing information resources.

The term “category” refers to a class or label defined within a predefined classification scheme, to which an information resource can be assigned based on its content or characteristics.

The term “category information” refers to data indicating one or more categories associated with an information resource, including identifiers, labels, or paths within a classification hierarchy.

The term “analysis result” refers to structured output produced by a natural language processing algorithm, including keyword information, topic information, entities, or other derived linguistic features.

The term “category proposal” refers to a category or set of categories suggested by a generative artificial intelligence model for an information resource, based on a prompt sentence and associated text data.

The term “emotional state” refers to an estimated affective condition of the user, such as satisfaction, frustration, confusion, or urgency, inferred from user behavior, input patterns, or response content.

The term “input behavior” refers to observable interaction patterns of the user with the terminal, including typing speed, correction frequency, query length, repetition of queries, and timing of operations.

The term “response content” refers to the textual or other data provided by the user in interaction with the system, which can be analyzed to estimate an emotional state.

The term “presentation order of search results” refers to the sequence and arrangement in which search results are displayed or otherwise presented to the user by the terminal.

The term “candidate information for autocomplete” refers to suggested query completions or related terms presented to the user while the user is entering a natural language query.

The term “machine translation algorithm” refers to a software-implemented method for automatically translating text data from one human language to another without human intervention.

The term “usage language of the user” refers to one or more preferred natural languages configured for or inferred for the user, in which information and interface elements are presented.

The term “notification message” refers to a message generated by the processor and transmitted to the terminal to inform the user about a system event, such as completion of automatic classification or availability of search results.

The term “communication line” refers to a logical or physical communication path, including wired or wireless networks and communication protocols, through which data is transmitted between the system and the terminal.

The term “technical document” refers to an information resource that describes technical matters, such as designs, architectures, specifications, or procedures, in a structured or semi-structured textual form.

The term “specification document” refers to a type of technical document that defines requirements, functions, constraints, or characteristics of a product, system, or process.

The term “keyword matching process” refers to an operation in which the processor compares query terms or keywords with terms contained in information resources to identify relevant information resources.

The term “document structure analysis process” refers to an operation in which the processor analyzes structural elements of a document, such as headings, sections, paragraphs, tables, and references, to derive or refine response information.

The term “degree of consistency” refers to a quantitative or qualitative measure indicating how closely an analysis result from a natural language processing algorithm aligns with a category proposal from a generative artificial intelligence model.

The term “reliability” refers to an estimated level of confidence or trustworthiness associated with a category proposal or analysis result, determined by the processor based on one or more criteria.

The term “final category” refers to a category selected or determined by the processor as the definitive category for an information resource after considering analysis results, category proposals, and consistency or reliability measures.

The term “clustering algorithm” refers to a data analysis method that groups information resources into clusters based on similarity measures applied to features such as keywords, topics, or categories.

The term “topic modeling algorithm” refers to a statistical or machine learning method that discovers latent topics in a collection of text data and associates information resources with one or more of the latent topics.

The term “reorganize the information resources” refers to an operation in which the processor updates internal data structures, indices, or groupings in the storage service to reflect clustering results, topic models, or final category assignments.

In one embodiment, a server provides a storage service that cooperates with one or more terminals operated by a user. The server includes at least one processor, a main memory, a non-volatile storage device, and a network interface. The processor executes computer-readable instructions stored in the non-volatile storage device and the main memory to implement the functions described below. The non-volatile storage device may be implemented by a magnetic storage device, a solid-state storage device, or a distributed storage system. The main memory may be implemented by a semiconductor memory. The network interface enables the server to communicate with the terminals via a wired or wireless network using a transport protocol.

The server stores information resources in a storage backend such as an object storage system or a file system. The server manages metadata of each information resource in a structured data store such as a relational database or a NoSQL database. The metadata includes at least a resource identifier, a user identifier, a storage location, timestamps, one or more categories, analysis results, and references to derived data such as extracted text and feature vectors.

The terminal operates as a client device that allows the user to upload information resources, issue natural language queries, view search results, and receive notifications. The terminal includes an input unit, a display unit, and a communication module. The terminal executes an application program such as a web browser or a dedicated client program. The terminal transmits user input and file data to the server and receives responses and notifications from the server.

The user operates the terminal to upload various information resources including text documents, technical specifications, design drawings in document form, and other digital files to the storage service. The server stores these information resources in the storage backend and records associated metadata. The server then performs automatic semantic analysis and classification as described below.

The server uses a text extraction module to obtain text data from the uploaded information resources. The text extraction module is implemented by a document parser capable of processing general document formats such as portable document formats, word processor formats, or markup-based formats. When the file is an image or a scanned document, the server applies an optical character recognition engine to convert embedded characters into machine-readable text. The server normalizes the extracted text by removing control characters, tokenizing the text, and converting text to a canonical form such as lowercase representation or Unicode normalization. The server maintains a text index structure that associates each resource identifier with a sequence of tokens and linguistic annotations. The server applies a natural language processing algorithm to the normalized text. In one embodiment, the server uses a pipeline composed of tokenization, part-of-speech tagging, syntactic parsing, named entity recognition, and topic inference. The server can implement these functions using a statistical or neural network-based natural language processing library. The server generates keyword information by selecting high-salience tokens based on measures such as term frequency-inverse document frequency or attention scores in a neural attention mechanism. The server generates topic information by applying a topic modeling algorithm such as a probabilistic topic model or a neural topic model to the collection of tokens. The server stores the keyword information and topic information in the metadata store in association with each resource identifier.

The server uses a generative AI model to understand user intent and to propose categories for information resources. In one embodiment, the generative AI model is implemented as a large-scale neural network having a transformer architecture. The transformer architecture includes multiple encoder-decoder layers, each layer comprising multi-head self-attention modules, feed-forward neural network modules, and normalization modules. The model parameters include weight matrices and bias vectors that are trained on large-scale text corpora using an unsupervised or semi-supervised learning method. The server stores a local copy of the model or accesses the model via an external inference service.

The server performs inference on the generative AI model by supplying a prompt sentence as an input sequence of tokens. The server converts the prompt sentence into embedding vectors using a token embedding matrix, applies positional encodings, and then propagates the vectors through the stacked attention layers. The model outputs a sequence of probability distributions over tokens. The server uses decoding techniques such as greedy decoding or beam search to obtain a textual response. The server extracts structured intention information or category labels from the response using a parsing procedure or a constrained decoding scheme that restricts output tokens to a predefined label set.

The server constructs the prompt sentence based on user input and analysis results. When the user issues a natural language query, the server includes the query text, contextual instructions, and optionally metadata of the user in the prompt sentence. An example of such a prompt sentence is:
“You are assisting a cloud storage system. Analyze the following user query and determine the user's intent for searching stored documents. Return a short description of the intent and indicate what type of documents should be retrieved.”

The server appends the user query text after the instruction. The server then provides the prompt sentence to the generative AI model and receives an output from which the server derives an intention category and priority. The server uses this intention information to select appropriate search strategies, ranking functions, and filters in the internal search engine.

When the server processes an uploaded information resource, the server constructs a different type of prompt sentence for category proposal. An example of such a prompt sentence is: “You are assisting a cloud storage system. Analyze the following document text and propose the single most appropriate category from this list: ‘Blueprint’, ‘Contract’, ‘Meeting Minutes’, ‘Specification’, ‘Report’, ‘Other’. Return only the category name.

Document text:
[extracted text here]”

The server replaces the placeholder with the extracted text. The generative AI model outputs a candidate category, and the server parses the output to obtain the proposed category as a label that is mapped to a category in the predefined classification scheme.

The server combines the category proposal from the generative AI model with results from the natural language processing algorithm. The server computes a feature vector for each information resource, the feature vector including at least keyword frequencies, topic probabilities, and a one-hot or embedding representation of the category proposed by the generative AI model. The server applies a rule-based classifier or a learned classifier to this feature vector to determine a final category. The rule-based classifier may incorporate constraints such as: if topic probability for a “design” topic exceeds a threshold and the generative AI model outputs a label corresponding to “Blueprint,” then the server sets the final category to “Blueprint” even when some keywords overlap with other categories. The learned classifier may be implemented by a gradient-boosted decision tree or a shallow neural network that outputs category probabilities. The server compares the model's probabilities with the rule-based outcome and selects a final category using a decision policy based on confidence scores and consistency.

The server estimates the emotional state of the user using observable interaction data. The terminal sends logs of input behavior to the server, including typing speed, number of corrections, query reformulations, and timing between requests. The server aggregates these features and applies a classifier trained to map feature patterns to emotional states such as “frustrated,” “confused,” or “calm.” The classifier may be implemented by a recurrent neural network or a transformer encoder that processes sequences of interaction events. The server also analyzes response content sent by the user (for example, feedback statements or follow-up queries) using sentiment analysis to refine the emotional state estimation.

The server uses the estimated emotional state to adjust internal parameters of the search and suggestion algorithms. For example, when the server detects a frustrated state, the server modifies the ranking function to increase the weight of high-confidence matches and reduce the diversity penalty, thereby presenting more direct and relevant results at the top of the list. The server also modifies autocomplete logic to propose shorter, more common queries and to reduce the sensitivity to minor spelling variation. These adjustments are implemented as changes in numerical weights and thresholds in the ranking and suggestion algorithms. By performing such adaptive control at the algorithm level, the server reduces the number of queries needed by the user to find a desired resource and decreases processing waste associated with repeated broad searches.

The server processes information resources written in different languages by incorporating a machine translation algorithm. The server detects the language of the text using language identification models. When the detected language differs from the usage language of the user, the server invokes a neural machine translation model to convert the text into the usage language. The neural machine translation model may also have a transformer architecture with encoder and decoder stacks. The server stores translated text alongside the original text in a dual-index structure. The dual-index structure includes an index over original-language tokens and an index over translated-language tokens, both linked to the same resource identifier. This structure allows the server to execute cross-language retrieval efficiently without repeatedly performing translation during each search, thus reducing processing time and network load.

The server uses specific data structures to manage analysis results and classification outcomes. For each information resource, the server stores a record in the metadata store comprising fields for resource identifier, user identifier, category identifier, keyword vector, topic vector, emotional-state-independent ranking score, and generative-AI-proposed label.

The server also maintains an inverted index mapping each category identifier to a list of resource identifiers sorted by composite ranking scores. The composite ranking scores are updated when new analysis results or updated emotional state estimations are obtained. This incremental update mechanism allows the server to reorganize information resources in near real time without recomputing all indices from scratch.

The server improves computer technology by integrating generative AI inference, natural language processing, and translation within a unified, low-latency pipeline that is optimized for storage and retrieval operations. The server reduces overall processing cost by avoiding redundant analysis: the server stores intermediate results such as keyword vectors, topic vectors, and generative AI outputs, and reuses these values when responding to subsequent queries instead of recalculating them. The server reduces communication load by transmitting compact identifiers and summarized metadata between internal modules rather than full text, and by storing translated text locally so that further cross-language queries do not require repeated external translation calls.

The server uses training procedures to construct and refine the classification and emotional state estimation models. During an offline training phase, the server collects labeled samples comprising text data, interaction features, and target labels such as categories or emotional states. The server uses an optimization algorithm such as stochastic gradient descent or its variants to minimize a loss function. For category prediction, the loss function may be a cross-entropy loss over category labels; for emotional state estimation, the loss function may be a weighted cross-entropy or a margin-based loss to emphasize correct distinction between confused and non-confused states. The server updates the model parameters by computing gradients of the loss with respect to the weights and performing parameter updates according to learning rate schedules and regularization terms. The server may apply data augmentation techniques, such as synonym replacement or random deletion of non-critical tokens, to increase robustness against variations in user queries and document phrasing.

The server applies non-conventional processing rules that differ from manual human categorization. For example, the server gives priority to latent topic structure and generative AI consistency scores over simple keyword counts, so that documents containing similar domain-specific terms but belonging to different functional categories are separated correctly. The server applies a specific rule that penalizes category assignments when the generative AI output exhibits low confidence, as inferred from dispersion of output token probabilities, and instead relies on internal topic-model-based classification. This multi-stage, confidence-aware decision process enables the server to avoid systematic misclassification that would arise if a single heuristic or a purely manual rule set were applied.

The server reorganizes information resources stored in the storage service by applying clustering algorithms and topic modeling algorithms in conjunction with the final category information. The server computes similarity metrics between feature vectors of information resources and groups them into clusters that respect both predefined categories and latent topic groupings. The server updates directory structures or virtual category views exposed to the terminal so that the user sees logically grouped resources rather than a flat list. This reorganization improves file retrieval performance, as the server can narrow search space to relevant clusters before applying full-text matching, thereby reducing computational overhead and improving response time.

In an alternative embodiment, the server integrates the generative AI model and the natural language processing algorithms into a single multi-task model. The server configures a shared encoder to process text from both user queries and information resources, and uses separate task-specific heads for intention detection, category prediction, and emotional state estimation. By sharing representations, the server reduces memory consumption and accelerates inference because a single forward pass through the encoder can provide features for multiple tasks. The server then combines outputs from the task-specific heads using defined decision policies to derive final search parameters, categories, and interface adjustments.

In another embodiment, the terminal performs part of the preprocessing. The terminal may locally normalize text, detect language, or cache frequently used query templates before sending them to the server. This reduces bandwidth and server-side processing. However, the complex semantic analysis, generative AI inference, and cross-language indexing remain on the server side, where sufficient computational resources and secure storage are available. This division of labor allows the system to maintain responsiveness even when many users access the storage service concurrently.

In a further embodiment, the server applies hardware acceleration to the neural network computations by using specialized processing units. The server deploys the generative AI model and the neural machine translation model on a parallel computing infrastructure to shorten inference time. The server manages batching of requests, vectorized computation, and memory reuse to avoid contention and to improve throughput. Through these techniques, the server achieves performance that would not be feasible with manual or purely rule-based processing.

By executing the described algorithms, managing the specified data structures, and controlling internal components of the storage service, the server provides technical effects such as improved accuracy of document retrieval, reduced latency in search operations, lower error rate in classification, and decreased communication overhead. The system does not merely automate human classification or translation; instead, the server introduces model-based decision logic, cross-language indexing structures, and emotional-state-adaptive control of ranking and suggestion algorithms. These features directly improve the functioning of the computer system itself, including the storage engine, the indexing subsystem, and the query processing pipeline.

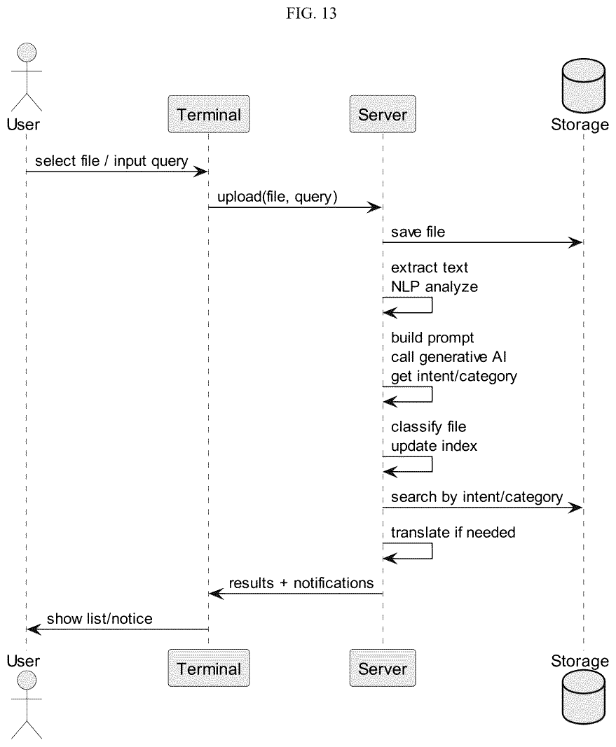

The following describes the processing flow using FIG. 13.

### Step 1:

The user operates the terminal to select an information resource to be uploaded to the storage service.

The input is a file stored in local storage of the terminal and a user identifier.

The terminal reads the binary data of the selected file from local storage, attaches the user identifier and basic metadata such as file name and size, and generates an upload request.

The terminal transmits the upload request to the server via a network connection using a secure communication protocol.

The output is a network message containing the file data and associated metadata sent from the terminal to the server.

### Step 2:

The server receives the upload request from the terminal through a network interface.

The input is the network message containing the binary file data, the user identifier, and metadata.

The server validates the request by checking authentication information, file size limits, and allowed file types, and then writes the file data to a storage backend, assigning a unique resource identifier.

The server stores an initial metadata record in a metadata store, including the resource identifier, user identifier, file location, upload time, and a status flag indicating that analysis is pending.

The output is a stored file in the storage backend and an initialized metadata record in the metadata store.

### Step 3:

The server extracts text data from the stored information resource using a text extraction module.

The input is the resource identifier and the binary file data retrieved from the storage backend.

The server parses the file format, performs operations such as decompression, character decoding, and layout analysis, and applies an optical character recognition process if the file is an image-based document.

The server normalizes the extracted text by removing control characters, applying tokenization, and converting characters to a canonical encoding scheme.

The output is normalized text data associated with the resource identifier and stored in the metadata store or a text index.

### Step 4:

The server analyzes the normalized text using a natural language processing algorithm.

The input is the normalized text data for the information resource.

The server applies tokenization, part-of-speech tagging, syntactic parsing, named entity recognition, and topic modeling to the text, and computes feature values such as term frequencies, topic probabilities, and entity types.

The server derives keyword information by selecting high-salience tokens according to statistical scores and derives topic information by assigning topic labels based on topic probabilities.

The output is a set of keyword information, topic information, and other linguistic features stored in association with the resource identifier.

### Step 5:

The server generates a prompt sentence for a generative AI model to obtain a category proposal for the information resource.

The input is the normalized text data, the keyword information, and the topic information.

The server constructs a textual instruction that specifies the task and a predefined list of candidate categories, and appends a portion of the document text as context.

The server embeds the analysis results implicitly or explicitly in the prompt sentence, for example by including a short summary or listing key terms.

The output is a prompt sentence in natural language prepared for input to the generative AI model.

### Step 6:

The server sends the prompt sentence to the generative AI model and receives a textual response.

The input is the prompt sentence generated in the previous step.

The server encodes the prompt sentence into tokens, transmits the tokens to the generative AI model, and executes inference on a neural network architecture using attention-based computations and feed-forward operations.

The server decodes the output token probabilities into a text string representing a proposed category, and validates that the text corresponds to one of the allowed categories.

The output is a category proposal label generated by the generative AI model.

### Step 7:

The server determines a final category for the information resource by combining internal analysis results and the category proposal from the generative AI model.

The input is the keyword information, the topic information, and the category proposal label.

The server constructs a feature vector that encodes term statistics, topic probabilities, and a representation of the proposed category, and applies a classification rule set or a learned classifier to compute scores for each possible category.

The server compares the scores with the category proposal and selects a final category using a decision policy based on consistency and confidence thresholds.

The output is a final category identifier stored in the metadata store as category information associated with the resource identifier.

### Step 8:

The server updates internal indices and data structures to reflect the assigned category.

The input is the resource identifier and the final category identifier.

The server inserts or updates entries in an inverted index mapping category identifiers to lists of resource identifiers, and recalculates composite ranking scores that combine relevance and category consistency.

The server writes updated index positions and ranking scores to index storage for efficient retrieval in subsequent search operations.

The output is an updated category index and ranking data that incorporate the newly classified information resource.

### Step 9:

The user operates the terminal to issue a natural language query to search stored information resources.

The input is a text string entered by the user through an input interface on the terminal.

The terminal packages the query text with the user identifier and transmits a search request message to the server over the network.

The terminal may optionally include additional parameters such as language preference or sorting options.

The output is a search request message sent from the terminal to the server.

### Step 10:

The server interprets the natural language query using a generative AI model to obtain intention information.

The input is the natural language query text and the user identifier.

The server constructs a prompt sentence that instructs the generative AI model to determine the user's search intent and to specify relevant document types or categories, and then sends the prompt sentence to the model.

The server receives the model's response, parses the response to extract structured intention information such as target categories, keywords, and desired level of detail, and represents this information as internal search parameters.

The output is intention information that guides the subsequent search process.

### Step 11:

The server performs a search over the indexed information resources based on the intention information and existing analysis results.

The input is the intention information, the user identifier, and the search indices including keyword, topic, and category indices.

The server computes similarity scores between the query representation and resource feature vectors, applies filters for categories and language, and ranks the candidate resources using a ranking function that combines keyword relevance, topic similarity, and category match.

The server selects top-ranked resource identifiers as search results and prepares summary snippets using stored text and analysis data.

The output is a ranked list of resource identifiers with associated summary information to be returned to the terminal.

### Step 12:

The server estimates the emotional state of the user based on observed interaction behavior and optionally on content of follow-up input.

The input is interaction logs such as query history, input timing, correction frequency, and previous search outcomes, along with any explicit feedback text from the user.

The server computes feature values representing the user's interaction pattern and applies an emotional state classifier to infer an emotional state label and an associated confidence score.

The server uses the estimated emotional state to adjust parameters of the ranking function and autocomplete suggestion logic, for example by modifying weight coefficients and thresholds.

The output is an updated set of search and suggestion parameters adapted to the user's current emotional state.

### Step 13:

The server executes a machine translation process when an information resource is written in a language different from the user's usage language.

The input is the text data of candidate search results and the user's usage language setting.

The server detects the language of each text using a language identification model, selects resources that require translation, and applies a neural machine translation algorithm to convert the text into the usage language.

The server stores translated text in a secondary index and associates the translated text with the corresponding resource identifiers to avoid redundant translation for future requests.

The output is translated text data in the user's usage language prepared for presentation to the user.

### Step 14:

The server generates response information and notification messages to be delivered to the terminal.

The input is the ranked and possibly translated search results, the final categories of those resources, and any classification updates that have occurred.

The server formats a response payload including a list of result items, each item containing a resource identifier, title, summary text, category label, and a link or reference for access, and generates a notification message when a new automatic classification or reclassification has been performed.

The server transmits the response payload as a search response and, when applicable, sends the notification message using an appropriate communication channel such as a push notification or in-app message.

The output is a search response and optional notification messages delivered from the server to the terminal.

### Step 15:

The terminal receives the search response and notification messages from the server and presents them to the user.

The input is the response payload containing ranked results and any notification messages.

The terminal parses the payload, constructs user interface elements such as lists grouped by category, and displays resource titles, summaries, and categories on the display unit.

The terminal presents notification messages indicating that specific information resources have been automatically classified into certain categories, and provides interactive controls for the user to open, download, or further refine searches.

The output is a visual and interactive presentation that enables the user to access and manage information resources based on the categories and search results generated by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information retrieval and question-answering systems typically treat natural language understanding, information search, auto-completion, translation, and emotion analysis as separate and loosely coupled modules. In many deployments, a search engine indexes stored data, a separate auto-complete component suggests queries based mainly on frequency statistics, a translation component translates text in isolation, and any sentiment analysis, if present, is applied only for post-hoc reporting. As a result, such systems often fail to provide responses that are well aligned with a user's actual intent and current emotional state, and cannot effectively control how a generative AI model uses stored data to construct final outputs.

In addition, known systems generally do not exploit text obtained from optical character recognition on images, together with generative AI models, as a unified signal for both classification of stored information and interactive answer generation. For example, in logistics or document-management environments, images containing text (such as labels or documents) are often processed by a simple OCR pipeline and then stored with minimal metadata. Subsequent classification and retrieval are handled by independent indexing processes that cannot dynamically instruct a generative AI model how to interpret the OCR text in light of current user context or query.

Furthermore, conventional auto-completion mechanisms are largely based on static dictionaries, n-gram frequencies, or simple machine-learning models trained exclusively on historical queries. These mechanisms do not dynamically adjust suggested completions based on a user's contemporaneous emotional state, recent interaction context, or the specific downstream task for which a generative AI model is being invoked. As a consequence, users are frequently presented with suggestions that are technically relevant but emotionally inappropriate or unhelpful for the user's current situation.

Moreover, existing systems do not tightly integrate the generation and dynamic control of prompt sentences for generative AI models with the search, classification, and translation pipelines. In many architectures, prompt sentences are hard-coded or manually constructed for a limited set of use cases. This restricts the system's ability to flexibly adapt prompt content to different input modalities (e.g., questions, OCR text, search results), to different processing goals (e.g., answer generation, auto-completion, classification, translation), and to runtime context such as the user's emotional state.

These architectural limitations lead to technical inefficiencies: multiple passes over the same data, redundant model calls, suboptimal use of compute resources, and increased latency due to ad-hoc orchestration of independent services. They also lead to reduced accuracy and user satisfaction, because the system cannot consistently align the behavior of the generative AI model with the specifics of the stored information and the dynamic user state.

Accordingly, there is a need for an improved computer-implemented system that (i) centrally orchestrates receipt of natural language questions, OCR-derived text, and search results; (ii) generates and dynamically controls prompt sentences for a generative AI model based on these heterogeneous inputs; (iii) automatically classifies structured and unstructured information into predefined classification groups; (iv) estimates a user's emotional state from multimodal interaction signals and adjusts both search results and auto-completion candidates accordingly; and (v) automatically performs cross-language translation in an integrated manner. Such a system should improve the operation of the underlying computing platform itself by reducing redundant processing, increasing relevance and appropriateness of outputs, and enabling more efficient and context-aware utilization of generative AI models and associated data-processing components.

The specific processing by the specific processing unit 290 of the data processing device 12 in Application Example 2 is realized by the following means.

The present invention provides a server comprising a processor configured to receive natural language information input from a user; analyze a received natural language question and generate a prompt sentence for instructing a generative AI model to understand an intention of the question, and input the prompt sentence to the generative AI model; access an information storage service based on an intention obtained from the generative AI model, search related information, and derive answer information; automatically classify structured information or unstructured information stored in the information storage service into predefined classification groups by using a statistical information processing technique or a document structure analysis technique; estimate an emotional state of the user on the basis of at least one of voice information, image information, and input operation information of the user, and select or rank at least one of the answer information, a search result, and an input completion candidate according to the emotional state; extract character string information included in image information sent from the user by optical character recognition processing, input the extracted character string information to the generative AI model to estimate a classification group, and assign the classification group to target information in the information storage service; generate a plurality of input completion candidates for a partial character string input from the user by using at least one of the generative AI model and a machine learning model, and adjust the input completion candidates based on at least one of history information of the user and the emotional state; automatically convert information expressed in different languages into a language specified by the user by using machine translation processing, and present the converted information as at least one of the answer information and the search result; and generate the prompt sentence to the generative AI model based on at least one of the natural language question from the user, the extracted character string information, and the search result, and dynamically control the prompt sentence so that the generative AI model constructs at least one of the answer information, a classification result, an input completion candidate, and a translation result as natural language text. This enables integrated and context-aware control of natural language understanding, information search, classification, auto-completion, translation, and emotion-adaptive response generation within a single computing architecture, thereby improving the technical operation of the computer system by reducing redundant processing, lowering response latency, increasing relevance and emotional appropriateness of outputs, and more efficiently orchestrating interactions with the generative AI model.

The term “natural language information input” refers to information expressed in a human language without requiring a formal command syntax, including sentences, phrases, or questions provided by a user via text, voice, or other input modalities.

The term “natural language question” refers to an interrogative expression provided by a user in a human language, which the system interprets to determine the user's information need or intended task.

The term “processor” refers to one or more hardware computing units, such as central processing units, graphics processing units, or dedicated accelerators, configured to execute instructions implementing the functions described in the claims.

The term “generative AI model” refers to a trained machine learning model that processes input data and generates natural language text or other structured outputs, based on statistical patterns learned from large datasets.

The term “prompt sentence” refers to a text string supplied as input to the generative AI model, which describes a task, provides context, or instructs the model how to interpret and respond to other data.

The term “intention of the question” refers to an underlying semantic goal or purpose of a user's natural language question, such as a requested action, desired information, or target object.

The term “information storage service” refers to a computer-implemented subsystem or platform that stores, manages, and provides access to digital information, including structured data and unstructured documents, via programmatic interfaces.

The term “related information” refers to information retrieved from the information storage service that is determined to be relevant to the user's intention or query context according to predefined criteria or learned models.

The term “answer information” refers to information derived, selected, or synthesized by the processor in response to a user's natural language question, and intended for presentation to the user as an answer.

The term “structured information” refers to information stored in a predefined data format such as tables, records, or key-value pairs, where fields and data types are explicitly defined.

The term “unstructured information” refers to information that does not conform to a rigid schema, such as free-form text, images, or mixed-content documents.

The term “predefined classification groups” refers to logical categories or classes specified in advance by configuration or system design, used to label or organize information for retrieval or analysis.

The term “statistical information processing technique” refers to a computational method that analyzes data using statistical measures or probabilistic models, such as frequency analysis, regression, or probabilistic classification.

The term “document structure analysis technique” refers to a computational method that analyzes the layout, sections, headings, or markup of a document in order to infer its components, hierarchy, or semantic segments.

The term “emotional state” refers to an estimated psychological condition of a user, such as happiness, sadness, anger, stress, or neutrality, inferred from user interaction signals.

The term “voice information” refers to audio data or derived features obtained from a user's spoken input, including properties such as pitch, volume, duration, and speech rate.

The term “image information” refers to visual data captured from a user or an environment, including still images, video frames, or derived visual features.

The term “input operation information” refers to data describing how a user interacts with an input device, including keypress timing, pointer movements, gesture patterns, or touch characteristics.

The term “search result” refers to information items or records returned by a search process performed on the information storage service in response to a query.

The term “input completion candidate” refers to a suggested text string that completes or extends a partial input provided by a user, and which can be selected to reduce typing or input effort.

The term “image information sent from the user” refers to visual data, such as photographs or screen captures, transmitted from a user device to the server for processing.

The term “optical character recognition processing” refers to a computational technique that detects and converts character shapes in image information into corresponding digital text representations.

The term “character string information” refers to a sequence of characters recognized or generated in digital form, such as letters, digits, or symbols constituting text.

The term “classification group” refers to a category assigned to information based on its content, context, or other attributes, used to organize, filter, or retrieve the information.

The term “target information” refers to specific data or records within the information storage service to which a classification group, label, or attribute is assigned.

The term “machine learning model” refers to a computational model that has been trained on example data to perform tasks such as prediction, classification, or ranking without being explicitly programmed for each rule.

The term “history information of the user” refers to stored data describing past interactions or behaviors of a user, such as previous queries, selections, or usage patterns.

The term “machine translation processing” refers to a computational method that automatically converts text from one natural language to another using algorithmic or learned transformation models.

The term “converted information” refers to information that has been transformed from a source language to a target language, or otherwise processed to change its representation while preserving its meaning.

The term “natural language text” refers to digital text expressed in a human language, structured as words, phrases, and sentences, suitable for human reading and understanding.

The term “information group” refers to a set or collection of information items, such as multiple documents, records, or text segments, treated as a unit for analysis or classification.

The term “feature quantities” refers to numerical or symbolic representations derived from information, such as word embeddings, term frequencies, or structural indicators, used as inputs to computational models.

The term “topic extraction technique” refers to a computational method that identifies latent themes or topics within text data, often by analyzing word co-occurrence patterns.

The term “clustering technique” refers to a computational method that partitions data points into groups based on similarity measures, without requiring explicit labels for each group.

In one embodiment, a server executes a program that implements the claimed functions using a set of cooperating software modules running on one or more processors. The server includes at least one general-purpose central processing unit (CPU), a main memory, a non-volatile storage device, and a network interface. In some configurations, the server further includes one or more graphics processing units (GPUs) or tensor accelerators optimized for matrix operations used in neural-network inference and training. A terminal includes a computing device such as a smartphone, tablet, wearable device, or personal computer, having an input unit (keyboard, touch panel, microphone, camera), a display unit, a local memory, and a communication module for establishing a network connection with the server. A user operates the terminal to provide natural language input, image data, and other interaction signals.

The server generates and stores an executable program composed of multiple modules, such as a natural language processing module, an optical character recognition module, a classification module, a generative AI orchestration module, an emotion analysis module, a translation module, and a data access module. The server allocates these modules as processes or threads and configures an inter-module messaging mechanism or function calls so that intermediate results (e.g., tokens, embeddings, classification labels) are passed through well-defined data structures in memory. In one example, the server uses a vector representation for tokens, such as a fixed-length floating-point array of dimension 768, and stores sequences of such vectors in contiguous memory regions to optimize cache locality and GPU batch execution.

The terminal provides a user interface allowing the user to enter natural language questions as text via a keyboard or touch input, or as speech via a microphone. The terminal optionally includes a camera for capturing image information, such as product labels, printed documents, or handwritten notes. The terminal preprocesses some input, for example normalizing audio sampling rates or compressing image data, and transmits such data to the server over a network using a communication protocol such as HTTPS. The server receives and buffers this data and writes it into an input queue for the appropriate processing pipeline. The server uses a natural language processing library implementation, for example based on tokenization and part-of-speech tagging algorithms similar to those provided by known frameworks, to segment a user's question into tokens, identify sentence boundaries, and extract candidate keywords and named entities. The server then constructs a prompt sentence that describes the user's question and the desired behavior of a generative AI model. For instance, when the user asks:
“Tell me about the battery life of the new product XYZ100.”
the server generates a prompt sentence such as:
“You are a technical assistant. Using only the information in the document excerpts below, answer the user's question clearly.
User question: ‘Tell me about the battery life of the new product XYZ100.’

### Document Excerpts:

1) ‘The XYZ100 can be used for approximately 10 hours of continuous video playback.’

2) ‘In standby mode, XYZ100 lasts up to 48 hours.’
Answer in one or two sentences.”

The server passes this prompt sentence, together with context segments, to a generative AI model. In one embodiment, the generative AI model is a transformer-based neural network comprising multiple self-attention layers, feed-forward layers, and layer normalization components. The model internally represents each token as an embedding vector and computes attention scores between tokens using scaled dot-product attention. The server stores model parameters (weights and biases) as arrays of floating-point values in GPU memory and performs forward propagation using parallel linear algebra operations executed on GPU cores. During training, the server uses a loss function such as cross-entropy for next-token prediction and performs gradient-based optimization (e.g., Adam optimizer) to update the weights. The server may pre-train the model on large unlabeled corpora and then fine-tune it on domain-specific documents to improve answer accuracy for technical queries.

The server accesses an information storage service implemented as a database system or search index. In one example, the server uses an inverted index data structure, where each token maps to a posting list of document identifiers, term frequencies, and positions. The data access module receives a representation of the user's question or the interpreted intention from the generative AI model and constructs a structured search query. The server then applies scoring functions, such as term-frequency-inverse-document-frequency (TF-IDF) or BM25, to compute similarity between the query and indexed documents. The server ranks the documents, extracts the most relevant passages, and provides them as document excerpts included in the prompt sentences. By doing so, the server constrains the generative AI model to rely on the retrieved information, thereby improving factual accuracy and reducing hallucinated responses.

The server performs automatic classification of structured and unstructured information stored in the information storage service. For this purpose, the server uses a classification model that maps each document or record into a predefined classification group. In one embodiment, the server computes feature quantities such as term frequency vectors, topic vectors derived from a topic extraction technique (e.g., Latent Dirichlet Allocation), or dense embeddings generated by the transformer encoder. The server then applies a classifier, such as a logistic regression model, a linear support vector machine, or a shallow neural network, to predict a label corresponding to a classification group. The server stores the predicted label as a field in the document record. This structure allows subsequent queries to filter and aggregate results by classification group, thereby reducing search space and latency.

The server also classifies information derived from image content. The terminal captures image information, such as a product label, and transmits the image to the server. The server invokes an optical character recognition module that segments the image into character regions and uses a trained recognition engine to convert bitmap patterns into character codes. The server then passes the recognized character string to the generative AI model with a prompt sentence such as:
“Analyze the following product label text and output a single, most appropriate product category for a warehouse inventory system.

Text: ‘New smartphone, model XYZ123, manufacturer ABC, 128 GB’.”

The generative AI model computes contextual representations of the tokens and outputs a short textual label indicating a classification group, such as “Electronics >Smartphones.”

The server maps this output to an internal categorical identifier and registers it in the information storage service. Because the server uses the same generative AI model for heterogeneous tasks (answer generation and categorization) but differentiates tasks by changing the prompt sentence, the architecture avoids separate task-specific models and reduces memory consumption and communication overhead.

The server estimates a user's emotional state from various interaction signals. The terminal collects voice information, including spectral features derived from microphone input, image information such as facial expressions captured by a camera, and input operation information such as keypress intervals, pointer movement speed, and correction frequency. The server aggregates these features, normalizes them, and feeds them into an emotion analysis network. In one embodiment, the emotion analysis network is a multi-layer perceptron that receives a concatenated feature vector and outputs probabilities for discrete emotional states such as “angry,” “stressed,” “neutral,” and “happy.” The server trains this network using supervised learning with labeled interaction records, minimizing a cross-entropy loss function. The server then uses the predicted emotional state to adjust search result ranking and input completion candidates. For example, when the user appears stressed, the server reduces the complexity of displayed information by prioritizing concise explanations and avoiding low-relevance documents that would otherwise burden the user.

The server generates input completion candidates for partial character string input. When the user begins typing a query, the terminal sends the partial string to the server. The server maintains a language model and a history-based model of previous queries. The language model predicts likely continuations based on token sequences, while the history-based model uses user-specific statistics. The server combines these models by calculating a weighted score for each candidate string, where the weight may depend on the emotional state. For instance, the server can favor shorter, high-frequency suggestions for a user detected as “rushed.” In another embodiment, the server uses the generative AI model itself to produce suggestion strings by providing a prompt sentence such as:
“The user typed the partial query ‘weath’. Suggest up to 5 likely complete search phrases in English that start with this prefix, ordered by general popularity.”

The generative AI model outputs a list of candidate strings, and the server computes additional scores based on stored usage frequencies and emotion-adaptive heuristics. The server returns the top candidates to the terminal, which displays them as selectable suggestions.

The server performs machine translation by invoking a translation module. This module implements a sequence-to-sequence neural network architecture, for example an encoder-decoder transformer, that maps an input token sequence in a source language to an output token sequence in a target language. The server stores translation models for multiple language pairs and selects the appropriate model based on the user's language preference.

The server segments text into subword units, calculates embeddings, and processes the sequence through stacked encoder and decoder layers. The translation module produces a sequence of tokens in the target language, which the server detokenizes into natural language text. Because this module is integrated with the search and classification pipeline, the server can automatically translate search results or answer information before presentation. For instance, when the user requests:
“Translate ‘The weather today is sunny.’ into Japanese.”
the server processes the request and returns:
“Today's weather is sunny.”

The server uses the tight coupling of the translation module with the generative AI orchestration module to generate prompt sentences that instruct the generative AI model to produce post-edited or context-aware translations when needed, rather than treating translation as an entirely separate subsystem.

The server generates and dynamically controls prompt sentences based on multiple inputs. For each user request, the server considers the natural language question, any OCR-derived character string information, and provisional search results. The generative AI orchestration module selects a prompt template corresponding to the current task type, inserts dynamic context such as document excerpts and emotional state descriptors, and adjusts parameters such as required answer length and style. For example, when the user is angry about project delays, the server creates a prompt sentence like:
“The user is angry about project delays. Using the following project status notes, generate a brief, calm, and empathetic explanation of the main delay reasons. Avoid assigning blame and focus on solutions.
User question: ‘Why is my project delayed again?’

### Project Notes:

1) . . .
2) . . . ”

This prompt design causes the generative AI model to generate content that is not only factually grounded in the notes but also tuned to the user's emotional state. Because the server maintains a library of prompt templates and adapts them programmatically at runtime, the system improves the consistency and predictability of generative AI outputs and reduces the need for manual prompt engineering.

The server, by integrating these modules in a cohesive architecture, achieves several technical effects beyond mere automation of human cognitive tasks. First, by using shared encoder representations and unified prompt-based task specification, the server reduces redundant processing, because the same tokenization and embedding computations can be reused for search, classification, and answer generation. This reduces processing time and energy consumption on the hardware level. Second, by storing classification groups and emotion-conditioned ranking signals in the information storage service, the server narrows the search space for subsequent queries, thereby lowering latency and network traffic between the server and the terminal. Third, by dynamically shaping prompt sentences with retrieved excerpts and user state data, the server reduces the probability that the generative AI model will produce irrelevant or hallucinated content, which directly improves the accuracy and reliability of system responses.

The server improves computer technology itself by redefining how a generative AI model is orchestrated within an information system. Traditional systems either apply generative models as isolated components or rely on static rules; in contrast, the server uses programmatically constructed, context-rich prompt sentences that encode retrieval results, classification outputs, and emotion labels as structured instructions. This non-conventional control mechanism alters the internal token distributions processed by the generative AI model and leads to more stable inference behavior. Furthermore, the integrated emotion-aware ranking and prompt control reduce the number of back-and-forth user interactions required to obtain a satisfactory answer, thereby decreasing total communication load and CPU utilization across the system.

The terminal in these embodiments operates as an intelligent peripheral rather than a simple input device. The terminal performs pre-processing such as audio normalization, frame rate adjustment, and basic error checking before transmitting data to the server. The terminal also manages result caching so that repeated display of the same suggestion set or translation does not require a new server request. By offloading certain tasks to the terminal, the system balances load between client and server and improves overall responsiveness.

The user, by interacting with the terminal, implicitly participates in training and adaptation of the system. For example, when the user selects or rejects auto-completion candidates, the terminal records these actions and reports them to the server as preference signals. The server aggregates such signals and updates model parameters or ranking weights, improving suggestion quality over time. This feedback loop is handled by dedicated logging and analytics modules and does not require the user to provide explicit labels or configuration. Multiple alternative embodiments are possible. In one variation, the server deploys separate generative AI models specialized for different tasks, such as a smaller, low-latency model for auto-completion and a larger, higher-capacity model for detailed answer generation. The server then selects which model to invoke based on factors such as input length, current system load, and required response time. In another variation, the server performs fine-tuning of the generative AI model on anonymized interaction logs collected from a specific deployment environment, thereby adapting the model to domain-specific terminology and stylistic preferences. In yet another variation, the server uses a rule-based filter before and after generative AI inference to enforce content policies, masking or rewriting certain outputs based on regular expressions or symbolic constraints.

In all these embodiments, the server, the terminal, and the user cooperate to realize an integrated system in which natural language questions, OCR-derived text, search results, emotion information, and translation tasks are processed through a unified generative AI orchestration framework. The described configurations, data structures, and model-control mechanisms enable the computer system to perform complex language-centric tasks with improved speed, accuracy, and context sensitivity, thereby constituting a concrete technological improvement rather than an abstract idea or mere automation of human reasoning.

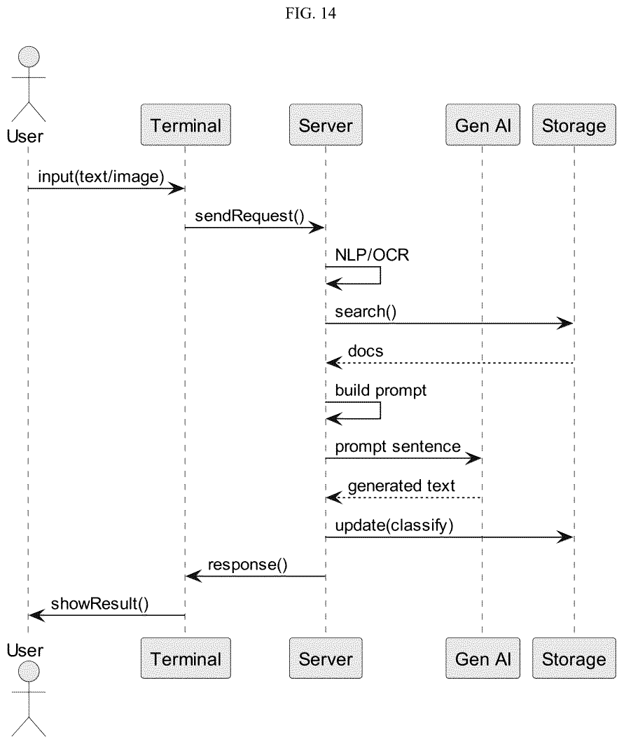

The following describes the processing flow using FIG. 14.

### Step 1:

User operates the terminal to provide input.

User enters a natural language question as text or speech, or captures an image such as a product label using a camera of the terminal. The input is, for example, a text string “Tell me about the battery life of the new product XYZ100.” or an image file containing printed characters.

### Step 2:

Terminal preprocesses and transmits the input to the server.

Terminal converts speech to text if necessary, compresses image data, attaches metadata (user ID, timestamp, language setting), and sends the resulting request to the server over a network. The input is raw user data (text, audio, or image); the output is a structured request message including normalized text and/or encoded image bytes.

### Step 3:

Server receives the request and routes it to appropriate modules.

Server examines request type flags (question, OCR, auto-complete, translation) and enqueues the data into corresponding processing pipelines. The input is the structured request message; the output is internal task descriptors stored in memory, each containing a reference to the user input and processing parameters.

### Step 4:

Server performs natural language preprocessing on text content.

Server tokenizes the question text into tokens, detects sentence boundaries, and extracts candidate keywords and named entities using a natural language processing library. The input is the raw question text; the output is a token sequence, a set of entities (e.g., product names), and a normalized representation used in later search and prompt construction.

### Step 5:

Server performs optical character recognition when image data is present.

Server applies OCR processing to image pixels, segments character regions, and recognizes characters using a trained recognition engine. The input is image data (e.g., a label photo); the output is character string information such as “New smartphone, model XYZ123, manufacturer ABC, 128 GB.”

### Step 6:

Server accesses the information storage service to retrieve candidate documents.

Server constructs a search query using extracted keywords, entities, or OCR text and executes the query against an index or database. The input is a normalized query representation; the output is a ranked list of document identifiers and associated text passages that are likely relevant to the user's intention.

### Step 7:

Server generates a prompt sentence for a generative AI model.

Server selects a prompt template based on the task type (e.g., Q&A, classification, auto-completion) and fills template slots with the user question, OCR-derived text, and selected document excerpts. The input is the task descriptor and retrieved passages; the output is a structured prompt sentence such as:
“You are a technical assistant. Using only the information in the document excerpts below, answer the user's question clearly.

User question: ‘Tell me about the battery life of the new product XYZ100.’

### Document Excerpts:

1) ‘The XYZ100 can be used for approximately 10 hours of continuous video playback.’

2) ‘In standby mode, XYZ100 lasts up to 48 hours.’

Answer in one or two sentences.”

### Step 8:

Server estimates the user's emotional state.

Server receives voice features, facial image features, and input operation metrics from the terminal, combines them into a feature vector, and applies an emotion analysis model to classify the emotional state. The input is multimodal interaction data; the output is an emotion label such as “angry,” “stressed,” or “happy” with corresponding confidence scores.

### Step 9:

Server adjusts search ranking and candidate selection using the emotional state.

Server modifies relevance scores of retrieved documents and filters or reorders them according to the detected emotion (for example, prioritizing concise, solution-oriented documents when the user is stressed). The input is the ranked document list and the emotion label; the output is an emotion-adjusted list of candidate passages for inclusion in the prompt sentence or for direct presentation.

### Step 10:

Server calls the generative AI model with the constructed prompt sentence.

Server sends the prompt sentence and any additional control parameters (e.g., maximum length, temperature) to the generative AI model, which runs inference to generate output tokens. The input is the prompt sentence text; the output is generated natural language text representing an answer, a classification label, or a set of suggestion strings, depending on the task.

### Step 11:

Server interprets and post-processes the generative AI model output.

Server parses the generated text to extract structured elements such as explicit category names, bullet-point steps, or suggestion lists. The input is the raw generated text; the output is structured data objects (e.g., answer object, category ID, candidate list) suitable for storage and presentation.

### Step 12:

Server updates classification information in the information storage service.

Server assigns classification groups to target records based on generative AI outputs or classifier predictions and writes these labels into the storage service. The input is structured classification data (e.g., “Electronics>Smartphones” for a label text); the output is updated records with new category fields that can be used in subsequent searches.

### Step 13:

Server generates input completion candidates for partial user input.

Server receives a partial string from the terminal and computes likely completions using a language model and user history statistics, optionally invoking the generative AI model with a prompt sentence such as:
“The user typed the partial query ‘weath’. Suggest up to 5 likely complete search phrases in English that start with this prefix, ordered by general popularity.”

The input is the partial string and user context; the output is a ranked list of completion candidate strings.

### Step 14:

Server adjusts input completion candidates according to the emotional state.

Server filters or reorders the completion candidates by applying emotion-dependent rules, such as favoring shorter or more neutral expressions when the user is stressed or sad. The input is the candidate list and the emotion label; the output is an adjusted suggestion list optimized for current user conditions.

### Step 15:

Server performs machine translation when cross-language output is required.

Server detects a mismatch between the language of the content and the user's preferred language and forwards the text to a translation module. The input is source-language text (e.g., answer information or document titles); the output is target-language text that preserves meaning, such as converting “The weather today is sunny.” into “Today's weather is sunny.”

### Step 16:

Server composes the final response payload for the terminal.

Server aggregates the processed components-answer information, classification labels, auto-completion candidates, and translated text-into a unified response structure. The input is multiple structured outputs from previous steps; the output is a response message that includes all necessary fields for display and interaction.

### Step 17:

Terminal receives and presents the response to the user.

Terminal parses the response message, updates display elements, and renders answer text, category information, suggestion lists, and translations in appropriate UI components. The input is the server response payload; the output is the visual and/or audible feedback that the user perceives on the terminal screen or speaker.

### Step 18:

User optionally provides feedback or continues interaction.

User selects an auto-completion candidate, refines the query, confirms or corrects a classification result, or requests additional translation or explanation. The input is the presented output on the terminal; the output is new user interaction events that are captured by the terminal and sent again to the server, thereby closing the processing loop and enabling continuous adaptation and improvement.

The data generation model 58 is a so-called generative artificial intelligence (AI). Examples of the data generation model 58 include generative Als such as ChatGPT (registered trademark) (Internet search <URL: https://openai.com/blog/chatgpt>) and the like.

The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

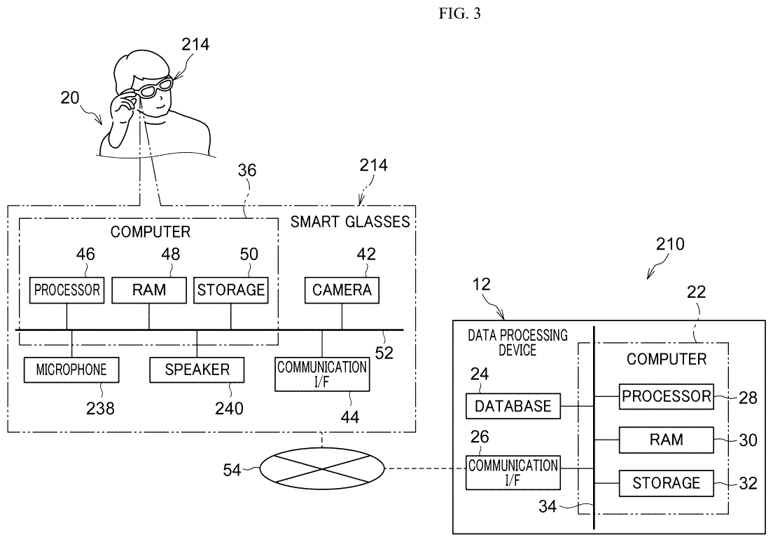

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

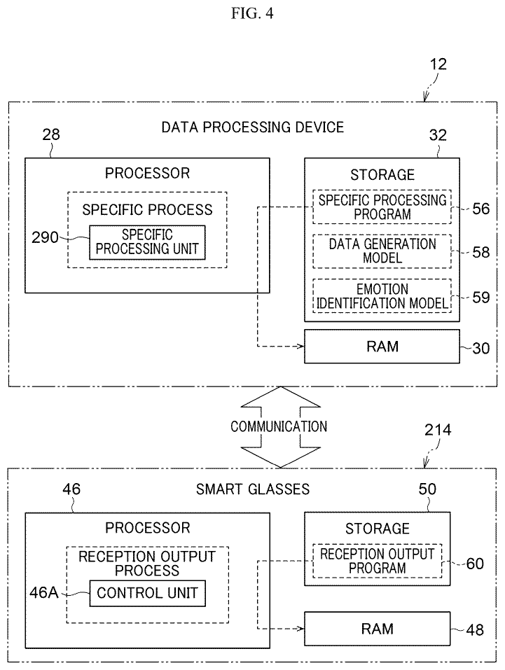

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

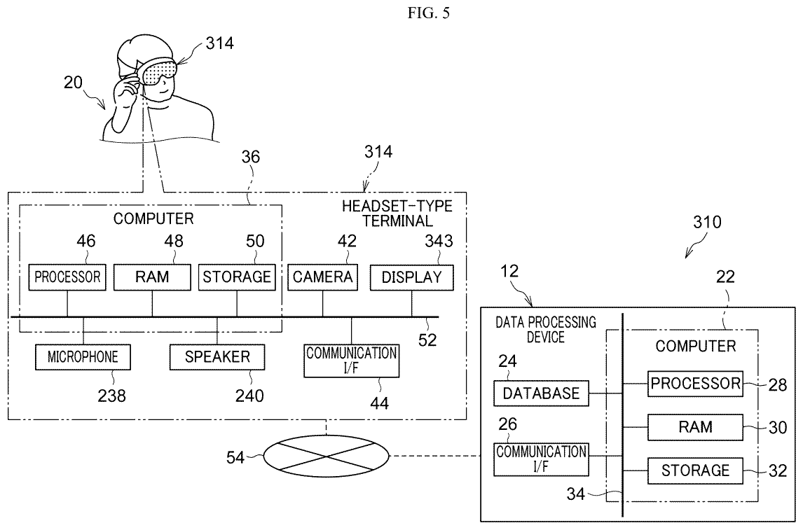

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

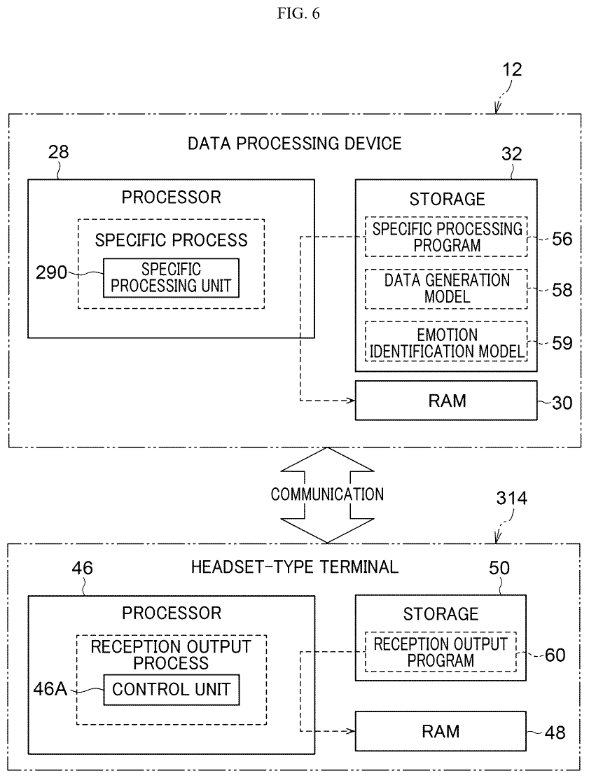

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

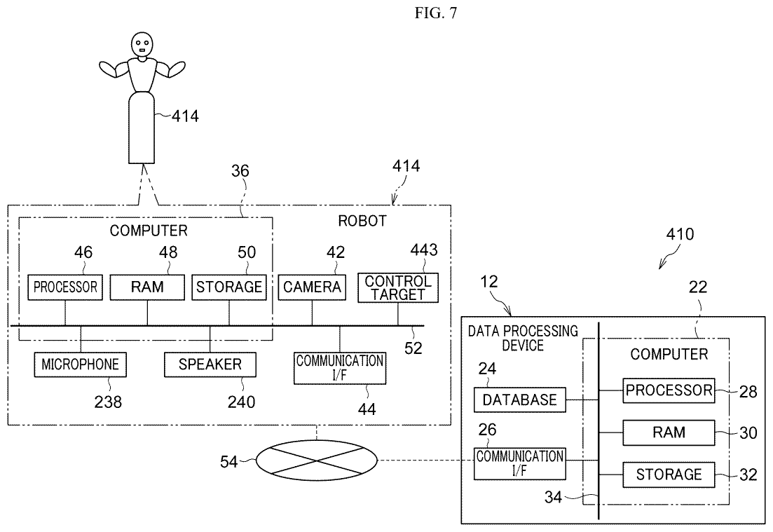

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

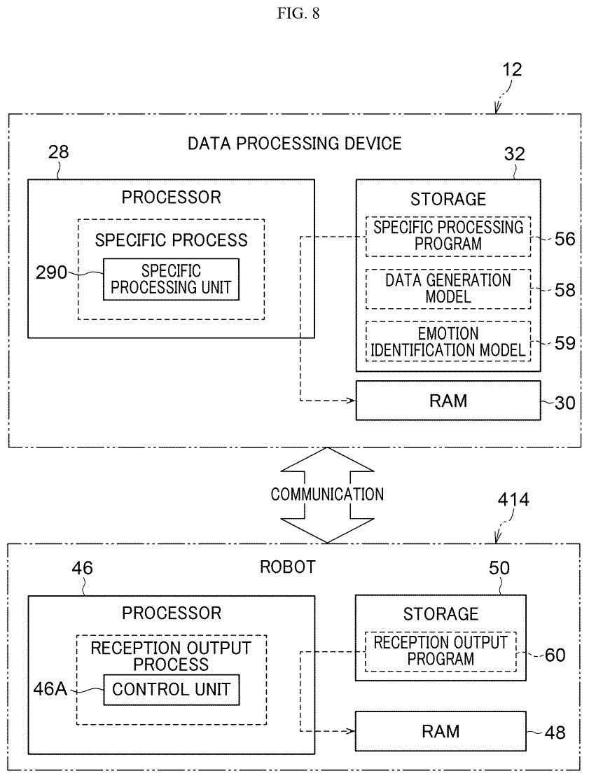

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

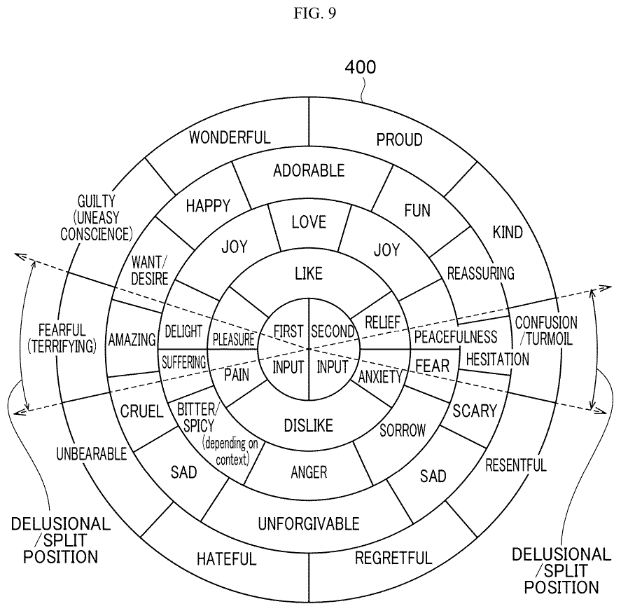

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

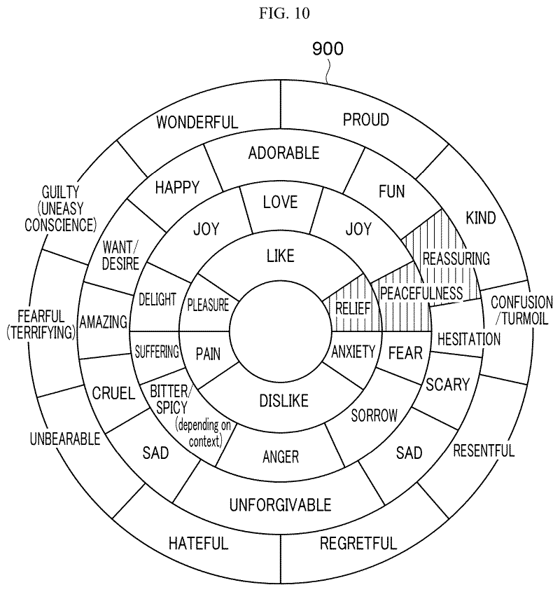

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal operated by a user, interface data including a question expressed in natural language, and transmit response data to the terminal via a communication network, convert the received natural-language question into an internal representation suitable for analysis, generate an analysis prompt sentence for extracting an intent and important terms of the question, input the analysis prompt sentence into a generative AI model, and obtain, from the generative AI model, a response indicating the intent and the important terms,
generate, on the basis of the obtained intent and important terms, a search request for information resources stored in an external storage service, acquire, from the external storage service, a plurality of documents including specification information and technical information, and extract, from the plurality of documents, text segments related to the question,
construct an answer-generation prompt sentence by combining the extracted text segments with the natural-language question, input the answer-generation prompt sentence into the generative AI model, and cause the generative AI model to generate an answer sentence in natural language based on the extracted text segments,
format the generated answer sentence into a predetermined output format, associate the formatted answer sentence with the question as response data, transmit the response data to the terminal, and cause the terminal to display the response data,
classify the plurality of documents or the text segments acquired from the external storage service automatically into categories based on topic information or attribute information,
estimate an emotional state of the user on the basis of utterance content or operation history of the user, and adjust at least one of the search request, the answer-generation prompt sentence, and an order of presentation on the terminal in accordance with the estimated emotional state, and
convert information resources in different languages stored in the external storage service into a unified language by machine translation processing, and generate the answer sentence on the basis of the information resources converted into the unified language.

### (Supplementary 2)

The system according to supplementary 1,
wherein the processor is configured to perform, on the documents acquired from the external storage service, a search process based on structural information analysis and full-text search, calculate, based on an analysis result of the generative AI model, a relevance score for each text segment of the documents, and include, in the answer-generation prompt sentence, only text segments whose relevance score exceeds a predetermined threshold.

### (Supplementary 3)

The system according to supplementary 1,
wherein the processor is configured to perform similarity computation or clustering computation based on distributed representations for the natural-language question and the text segments extracted from the documents, automatically assign the documents or the text segments to categories according to a result of the computation, and selectively change content or structure of the answer-generation prompt sentence input to the generative AI model by using category information.

### Application Example 1

### (Supplementary 1)

A system comprising a processor,
wherein the processor is configured to
receive, from a terminal including a display device and an input device, inquiry data including a natural-language question from a user, terminal identification information, and language information,
analyze the natural-language question included in the inquiry data by using a natural-language processing algorithm that performs morphological analysis, syntactic analysis, and named-entity extraction, and extract, from the question, topic-indicating expressions, product identification information, and category candidates,
generate a prompt sentence for causing a generative information processing algorithm to perform intent interpretation of the question and answer generation based on the question and the extracted topic-indicating expressions and the category candidates, and input the prompt sentence to the generative information processing algorithm,
generate a search condition for a storage device accessible via a communication network based on intent information and category information corresponding to the question, the intent information and the category information being output from the generative information processing algorithm, and search the storage device for product information, description information, and regulation information based on the search condition to thereby acquire related information,
classify the acquired related information automatically into higher-level categories including at least warranty information, return conditions, usage information, specification information, and store policy information by using a predefined information category hierarchy and a machine-learning algorithm,
construct, based on the related information and the question, a prompt sentence including constraint conditions such that content of the related information is preserved, input the prompt sentence to the generative information processing algorithm, and cause the generative information processing algorithm to generate a natural-language answer sentence, thereby deriving an answer to the question,
estimate an emotional state of the user at a time of question input or at a time of answer generation by using an emotion estimation algorithm, and adjust an expression of the answer sentence and an amount of supplementary information to be presented in accordance with the emotional state and also change a priority of completion candidates for a partially input question sentence,
perform, when a language of at least one of the question, the related information, and the answer sentence is different from a desired language of the user, automatic translation of at least one of the question, the related information, and the answer sentence into the desired language of the user by using a machine translation algorithm, and
transmit the answer sentence and identification information of the related information on which the answer sentence is based to the terminal, and cause the terminal to display the answer sentence.

### (Supplementary 2)

The system according to supplementary 1,
wherein the processor is configured to specify information to be used for the answer by applying, based on the topic-indicating expressions and the product identification information extracted from the question, a search condition to data structures representing specification information and technical information in the storage device and performing relevance evaluation based on expression matching, document structure information, and metadata.

### (Supplementary 3)

The system according to supplementary 1,
wherein the processor is configured to extract features from information stored in the storage device by using a natural-language processing algorithm, automatically classify the information into a plurality of category groups by using a topic extraction algorithm and a clustering algorithm, and use the category groups as filter conditions in generating the prompt sentence for the generative information processing algorithm and in searching for the related information.

### Example 2

### (Supplementary 1)

A system comprising a processor,
wherein the processor is configured to
receive, from a terminal operated by a user, an access request for acquiring an information resource stored in a storage service,
receive, from the user, a natural language query related to the access request, analyze the natural language query, generate a prompt sentence for causing a generative artificial intelligence model to understand an intention of the query, input the prompt sentence to the generative artificial intelligence model, and obtain intention information from the generative artificial intelligence model,
execute a search process on information resources stored in the storage service based on the intention information, extract a related information resource, and derive response information,
extract text data from an information resource stored in the storage service or from the extracted information resource, and analyze the text data using a natural language processing algorithm to obtain keyword information or topic information,
automatically classify the information resource into a category according to a predefined classification scheme based on the keyword information or the topic information, and record category information in association with the information resource,
input, to the generative artificial intelligence model, a prompt sentence including the text data and an analysis result of the natural language processing algorithm, obtain category information proposed by the generative artificial intelligence model, and correct or select the proposed category information so as to be consistent with a category in the predefined classification scheme,
estimate an emotional state of the user based on an input behavior or response content of the user, and adjust at least one of a presentation order of search results and candidate information for autocomplete based on the emotional state,
execute, for an information resource stored in the storage service and described in a different language, an automatic translation process using a machine translation algorithm, and present the translated information resource in a usage language of the user, and
generate a notification message for notifying the user of the category information of the information resource automatically classified, and transmit the notification message to the terminal via a communication line.

### (Supplementary 2)

The system according to supplementary 1,
wherein the processor is configured to execute a keyword matching process or a document structure analysis process on a technical document or a specification document stored in the storage service to derive the response information, and present the response information to the user in combination with the intention information obtained from the generative artificial intelligence model.

### (Supplementary 3)

The system according to supplementary 1,
wherein the processor is configured to compare an analysis result obtained by the natural language processing algorithm with a category proposal obtained from the generative artificial intelligence model, determine a final category based on at least one of a degree of consistency and a reliability, and reorganize the information resources stored in the storage service by using at least one of a clustering algorithm and a topic modeling algorithm based on the final category.

### Application Example 2

### (Supplementary 1)

A system comprising a processor,
wherein the processor is configured to
receive natural language information input from a user, and
analyze a received natural language question and generate a prompt sentence for instructing a generative AI model to understand an intention of the question, and input the prompt sentence to the generative AI model, and
access an information storage service based on the intention obtained from the generative AI model, search related information, and derive answer information, and automatically classify structured information or unstructured information stored in the information storage service into predefined classification groups by using a statistical information processing technique or a document structure analysis technique, and
estimate an emotional state of the user on the basis of voice information, image information, or input operation information of the user, and select or rank at least one of the answer information, a search result, and an input completion candidate according to the emotional state, and
extract character string information included in image information sent from the user by optical character recognition processing, input the extracted character string information to the generative AI model to estimate a classification group, and assign the classification group to target information in the information storage service, and
generate a plurality of input completion candidates for a partial character string input from the user by using at least one of the generative AI model and a machine learning model, and adjust the input completion candidates based on at least one of history information of the user and the emotional state, and
automatically convert information expressed in different languages into a language specified by the user by using machine translation processing, and present the converted information as at least one of the answer information and the search result, and
generate the prompt sentence to the generative AI model based on at least one of the natural language question from the user, the extracted character string information, and the search result, and dynamically control the prompt sentence so that the generative AI model constructs at least one of the answer information, a classification result, an input completion candidate, and a translation result as natural language text.

### (Supplementary 2)

The system according to supplementary 1,
wherein the processor is configured to derive the answer information from technical material or explanatory material stored in the information storage service by using at least one of word matching processing and document structure analysis processing.

### (Supplementary 3)

The system according to supplementary 1,
wherein the processor is configured to extract feature quantities from an information group stored in the information storage service by using a natural language processing technique, and automatically classify the information group into the classification groups by using at least one of a topic extraction technique and a clustering technique.

What is claimed is:

1. A system comprising:
circuitry configured to:
receive inquiry data comprising a natural-language question, terminal identification information, and language information from a terminal;
analyze the natural-language question using a natural-language processing algorithm that performs morphological analysis, syntactic analysis, and named-entity extraction to obtain topic-indicating expressions, product identification information, and category candidates;
acquire related information from a network-accessible storage device based on the topic-indicating expressions, the product identification information, and the category candidates;
construct structured prompt sentences that explicitly encode the natural-language question, the topic-indicating expressions, the category candidates, and constraint conditions preserving contents of the related information; and
supply the structured prompt sentences to a generative artificial intelligence model to obtain intent information, category information, and a natural-language answer sentence constrained by the related information, and transmit the natural-language answer sentence to the terminal.

2. The system of claim 1, wherein the circuitry is configured to:
apply an emotion recognition algorithm to the inquiry data to determine an emotional state of a user; and
adjust at least one of a response style, a degree of detail, and an answer organization of the natural-language answer sentence based on the determined emotional state.

3. The system of claim 2, wherein the emotion recognition algorithm applies a transformer-based sentiment classifier to emotion-indicative expressions extracted from the natural-language question to generate an emotional state category comprising at least one of a frustrated state, an anxious state, a neutral state, and an urgent state.

4. The system of claim 3, wherein adjusting the response style based on the emotional state category comprises incorporating an emotional state instruction token into the structured prompt sentences that directs the generative artificial intelligence model to generate the natural-language answer sentence in a tone and structure corresponding to the emotional state category.

5. The system of claim 4, wherein the circuitry is configured to:
adjust autocomplete suggestion priorities presented to the terminal based on the determined emotional state, such that suggestions associated with urgency-related inquiry types receive higher priorities when the emotional state category indicates an urgent or frustrated state.

6. The system of claim 1, wherein the natural-language processing algorithm applies a morphological analyzer to segment the natural-language question into morpheme-level units and assign grammatical attributes to each unit, and applies a dependency parser to determine syntactic relations among the morpheme-level units.

7. The system of claim 6, wherein named-entity extraction identifies tokens in the natural-language question labeled as at least one of a product name, an organization name, a model identifier, or a date expression, and assigns each identified token to a corresponding entity type category.

8. The system of claim 1, wherein constructing the structured prompt sentences comprises serializing the natural-language question, the topic-indicating expressions, the category candidates, and the constraint conditions into a structured prompt template that specifies an output format constraint and a context section containing the related information.

9. The system of claim 8, wherein the constraint conditions specify that the generative artificial intelligence model is to generate the natural-language answer sentence using only factual content derived from the related information, thereby suppressing generation of content not supported by the related information.

10. The system of claim 1, wherein the related information comprises at least one of product information, description information, and regulation information retrieved from the network-accessible storage device based on the product identification information and the category candidates.

11. The system of claim 10, wherein acquiring the related information comprises executing a structured query against the network-accessible storage device using the product identification information as a primary key and the category candidates as filter conditions.

12. The system of claim 1, wherein the circuitry is configured to:
apply a multilingual translation algorithm to the natural-language answer sentence when the language information indicates a target language different from a processing language of the generative artificial intelligence model, to generate a translated answer sentence for transmission to the terminal.

13. The system of claim 12, wherein the multilingual translation algorithm applies a sequence-to-sequence neural translation model trained on parallel text corpora to convert the natural-language answer sentence into the target language.

14. The system of claim 1, wherein the intent information comprises a machine-parseable representation of a user's objective derived from the natural-language question, and wherein the category information comprises one or more category labels assigned to the inquiry by the generative artificial intelligence model.

15. The system of claim 1, wherein the generative artificial intelligence model is a large language model accessed via a network interface, and wherein supplying the structured prompt sentences comprises transmitting a prompt request payload to the generative artificial intelligence model via an application programming interface.

16. The system of claim 1, wherein the circuitry is configured to:
generate autocomplete suggestion candidates based on the topic-indicating expressions and the category candidates, and transmit the autocomplete suggestion candidates to the terminal for presentation during entry of the natural-language question.

17. The system of claim 16, wherein generating autocomplete suggestion candidates comprises querying a suggestion index stored in a storage medium using the topic-indicating expressions as prefix keys and ranking returned candidates by a relevance score computed from the category candidates.

18. A system comprising:
circuitry configured to:
receive inquiry data comprising a natural-language question, terminal identification information, and language information from a terminal;
apply morphological analysis, syntactic analysis, and named-entity extraction to the natural-language question to obtain topic-indicating expressions, product identification information, and category candidates;
acquire related information from a network-accessible storage device based on the topic-indicating expressions and the product identification information;
construct structured prompt sentences encoding the natural-language question, the topic-indicating expressions, the category candidates, and constraint conditions preserving the related information, and supply the structured prompt sentences to a generative artificial intelligence model to obtain a natural-language answer sentence; and
apply an emotion recognition algorithm to the inquiry data to determine an emotional state and adjust at least one of a response style and a degree of detail of the natural-language answer sentence based on the emotional state.

19. The system of claim 18, wherein the circuitry is configured to apply a multilingual translation algorithm to the natural-language answer sentence when the language information indicates a target language different from a processing language of the generative artificial intelligence model, to generate a translated answer sentence for transmission to the terminal.

20. A method performed by circuitry, the method comprising:
receiving inquiry data comprising a natural-language question, terminal identification information, and language information from a terminal;
applying morphological analysis, syntactic analysis, and named-entity extraction to the natural-language question to obtain topic-indicating expressions, product identification information, and category candidates;
acquiring related information from a network-accessible storage device based on the topic-indicating expressions, the product identification information, and the category candidates;
constructing structured prompt sentences that explicitly encode the natural-language question, the topic-indicating expressions, the category candidates, and constraint conditions preserving contents of the related information;
supplying the structured prompt sentences to a generative artificial intelligence model to obtain intent information, category information, and a natural-language answer sentence constrained by the related information;
applying an emotion recognition algorithm to the inquiry data to determine an emotional state and adjusting at least one of a response style, a degree of detail, and an answer organization of the natural-language answer sentence based on the emotional state; and
transmitting the natural-language answer sentence to the terminal.
